(19) United States
(12) Patent Application Publication
(10) Pub. No.: US 2026/0340705 A1
(43) Pub. Date: Oct. 29, 2026

(54) RECOMMENDATION BASED INTERACTION METHOD AND APPARATUS, DEVICE, MEDIUM, AND PRODUCT

(71) Applicant: Tencent Technology (Shenzhen) Company Limited, Shenzhen (CN)

(72) Inventors: Haoran DING, Shenzhen (CN); Shuyuan LI, Shenzhen (CN); Peng SHI, Shenzhen (CN); Peiyao CHENG, Shenzhen (CN); Ziyue ZHENG, Shenzhen (CN); Zihao XIE, Shenzhen (CN); Guangzheng LUO, Shenzhen (CN); Peiqin ZHENG, Shenzhen (CN); Renqiang XIE, Shenzhen (CN); Yongwen LIU, Shenzhen (CN); Yijie JIANG, Shenzhen (CN); Yitao HOU, Shenzhen (CN)

(73) Assignee: Tencent Technology (Shenzhen) Company Limited, Shenzhen (CN)

(21) Appl. No.: 19/702,289

(22) Filed: Jun. 9, 2026

Related U.S. Application Data
(63) Continuation of application No. PCT/CN2025/099814, filed on Jun. 9, 2025.

(30) Foreign Application Priority Data
Aug. 27, 2024 (CN) 202411187678.5

(51) Int. Cl. G06Q 30/0601; G06F 3/04815; G06F 3/0482; G06T 19/00

(52) U.S. Cl. CPC G06Q 30/0631; G06F 3/04815; G06F 3/0482; G06Q 30/06433; G06T 19/006

(57) ABSTRACT

A method for recommendation-based interaction includes displaying a recommendation medium of a first recommended product and a virtual interactive control; displaying a camera capture preview interface based on a trigger operation on the virtual interactive control, the camera capture preview interface comprising prompt information configured to guide capture of a target object image; and displaying, on a virtual trial interface based on the target object image satisfying a capture condition, an associated effect of a physical attribute corresponding to a target recommended product on a target part, the target part comprising a location in the target object image that is related to an action location of the first recommended product. The target recommended product includes the first recommended product or a second recommended product belonging to a same type as the first recommended product.

### CROSS-REFERENCE TO RELATED APPLICATION

This application is a bypass continuation application of International Patent Application No. PCT/CN2025/099814, filed on Jun. 9, 2025, which claims priority to and is based on Chinese Patent Application No. 202411187678.5, filed on Aug. 27, 2024, the disclosures of which are incorporated herein in their entireties by reference.

### FIELD

Some embodiments of the present disclosure relate to the field of computer interface, and in particular, to a recommendation-based interaction method and apparatus, a device, a medium, and a product.

### BACKGROUND

Electronic devices may provide photos or videos of recommendations to end users. For example, electronic devices may display these images or videos via an interface (e.g., a graphical user interface (GUI)). However, because the images may be static and the videos may be in short form, there may be limited interaction between the user and the electronic device with respect to the recommendations. Because this limited interaction may cause a low click-through rate, computing resources used to generate such photos, videos, and interfaces can be wasted for generating less effective content.

### SUMMARY

According to some embodiments of the present disclosure, a method for recommendation-based interaction includes displaying a recommendation medium of a first recommended product and a virtual interactive control; displaying a camera capture preview interface based on a trigger operation on the virtual interactive control, the camera capture preview interface comprising prompt information configured to guide capture of a target object image; and displaying, on a virtual trial interface based on the target object image satisfying a capture condition, an associated effect of a physical attribute corresponding to a target recommended product on a target part, the target part comprising a location in the target object image that is related to an action location of the first recommended product. The target recommended product includes the first recommended product or a second recommended product belonging to a same type as the first recommended product.

According to some embodiments of the present disclosure, An apparatus for recommendation based interaction includes at least one memory configured to store computer program code; and at least one processor configured to read the program code and operate as instructed by the program code. The program codes includes a display code. The display code is configured to cause the at least one processor to, display a recommendation medium of a first recommended product and a virtual interactive control; display a camera capture preview interface based on a trigger operation on the virtual interactive control, the camera capture preview interface comprising prompt information configured to guide capture of a target object image; and display, on a virtual trial interface based on the target object image satisfying a capture condition, an associated effect of a physical attribute corresponding to a target recommended product on a target part, the target part being a location in the target object image that is related to an action location of the first recommended product. The target recommended product includes the first recommended product or a second recommended product belonging to a same type as the first recommended product.

According to some embodiments of the present disclosure, a non-transitory computer-readable storage medium, storing computer program code, when executed by at least one processor, causes the at least one processor to at least, display a recommendation medium of a first recommended product and a virtual interactive control, display a camera capture preview interface based on a trigger operation on the virtual interactive control, the camera capture preview interface comprising prompt information configured to guide capture of a target object image, and display, on a virtual trial interface based on the target object image satisfying a capture condition, an associated effect of a physical attribute corresponding to a target recommended product on a target part, the target part being a location in the target object image that is related to an action location of the first recommended product. The target recommended product includes the first recommended product or a second recommended product belonging to a same type as the first recommended product.

Some embodiments provide, without limitation, improvements in computer technology or any other technical field.

The first recommended product and the virtual interactive control are displayed on a short video playback interface, so that the user may trigger the virtual interactive control to enter the camera capture preview interface, and interact on the camera capture preview interface based on the prompt information. After the target object image satisfies the capture condition, the association effect between the physical attribute corresponding to the target recommended product and the target part in the target object image is displayed on the virtual trial interface. The association effect is a virtual product effect of the target recommended product. For example, augmented reality (AR) interaction is performed based on the prompt information, a wearing or use effect of the target recommended product is previewed through AR, and the virtual product effect of the target recommended product is displayed on the target part in an AR form, ensuring fusion of the virtual product effect of the target recommended product and a real scenario.

Further, a same product as the recommended product (the first recommended product) or a product of a similar type is recommended to the user through the trigger operation on the virtual interactive control, implementing a personalized recommendation service. Such a recommendation manner not only improves recommendation accuracy, but also increases an interaction frequency between the user and an advertisement, improving a click-through rate of the advertisement. As a result of generating more effective and personalized content, computing resources to generate images, videos, and interface can be saved.

### BRIEF DESCRIPTION OF THE DRAWINGS

To describe the technical solutions in some embodiments of the present disclosure more clearly, the following briefly describes the drawings required for describing the embodiments. It is clear that the drawings in the following descriptions show merely some embodiments of the present disclosure, and a person of ordinary skill in the art may still derive other drawings from these drawings without creative efforts.

FIG. 1 is a diagram of an architecture of a computer system according to some embodiments of the present disclosure.

FIG. 2 is a schematic diagram of a recommendation-based interaction method according to some embodiments of the present disclosure.

FIG. 3 is a flowchart of a recommendation-based interaction method according to some embodiments of the present disclosure.

FIG. 4 is a schematic diagram of a recommendation-based interaction method according to some embodiments of the present disclosure.

FIG. 5 is a schematic diagram of a recommendation-based interaction method according to some embodiments of the present disclosure.

FIG. 6 is a flowchart of a recommendation-based interaction method according to some embodiments of the present disclosure.

FIG. 7 is a flowchart of a recommendation-based interaction method according to some embodiments of the present disclosure.

FIG. 8 is a schematic diagram of a recommendation-based interaction method according to some embodiments of the present disclosure.

FIG. 9 is a schematic diagram of a recommendation-based interaction method according to some embodiments of the present disclosure.

FIG. 10 is a schematic diagram of a recommendation-based interaction method according to some embodiments of the present disclosure.

FIG. 11 is a schematic diagram of a recommendation-based interaction method according to some embodiments of the present disclosure.

FIG. 12 is a sequence diagram of a recommendation-based interaction method according to some embodiments of the present disclosure.

FIG. 13 is a block diagram of a structure of a recommendation-based interaction apparatus according to some embodiments of the present disclosure.

FIG. 14 is a schematic diagram of a structure of a computer device according to some embodiments of the present disclosure.

### DETAILED DESCRIPTION

To make objectives, technical solutions, and advantages of the present disclosure clearer, the following further describes implementations of the present disclosure in detail with reference to the drawings.

The term, involved in the following description, “some embodiments” describes subsets of all possible embodiments, but “some embodiments” may be the same subset or different subsets of all the possible embodiments and may be combined with each other without conflict.

The operations, techniques, and processes described herein may be implemented via executable instructions or computer program code stored on computer-readable medium. Such computer program code may include distinct portions or modules, where each portion comprises a subset of the total instructions necessary to perform specific operations.

Exemplary embodiments are described in detail herein, and examples of the exemplary embodiments are presented in the drawings. When the following descriptions involve the drawings, unless otherwise denoted, the same numerals in different drawings denote the same or similar elements. Implementations described in the following exemplary embodiments do not represent all implementations consistent with the present disclosure. Instead, the implementations are merely examples of apparatuses and methods that are described in detail in the appended claims and that are consistent with some aspects of the present disclosure.

Terms such as “set” (e.g., “a set of items”) or “subset” unless otherwise noted or contradicted by context, is to be construed as a nonempty collection including one or more members. Further, unless otherwise noted or contradicted by context, term “subset” of a corresponding set does not necessarily denote a proper subset of corresponding set, but subset and corresponding set may be equal.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

Terms used in the present disclosure are merely for the purpose of describing specific embodiments, but are not intended to limit the present disclosure. The singular forms of “a/an”, “the”, and “this” used in the present disclosure and the appended claims are intended to include plural forms as well, unless the context clearly indicates otherwise. The term “and/or” used herein indicates and includes any or all possible combinations of one or more associated listed items.

Although the terms “first”, “second”, and the like may be used in the present disclosure to describe various information, the information is not limited to these terms. These terms are merely used to differentiate the same type of information. For example, without departing from the scope of this disclosure, a first parameter may also be referred to as a second parameter, and similarly, the second parameter may also be referred to as the first parameter. Depending on the context, for example, the word “if” used herein may be interpreted as “while”, “when”, or “in response to determining.”

An expression, “a and/or b” may be understood as including only a, only b and both a and b. Expressions “at least one of a, b, and c” and “at least one of a, b, or c” may be understood as including only a, only b, only c, both a and b, both a and c, both b and c, or all of a, b, and c. Also, expressions such as ‘a, b, or c’ may be understood as ‘at least one of a, b, or c’ unless explicitly stated otherwise, or unless the elements would only be understood as alternatives by a person ordinarily skilled in the art.

Further, unless stated otherwise or otherwise clear from context, phrase “based on” may refer to “based at least in part on” and not “based solely on.”

In the present disclosure, before and during collection of relevant data (for example, operation data involved in the present disclosure) of a user, a prompt interface or a pop-up window may be displayed, or voice prompt information may be outputted. The prompt interface, the pop-up window, or the voice prompt information is configured for prompting the user that the relevant data of the user is currently collected. In this way, in the present disclosure, only after a confirmation operation of the user for the prompt interface or the pop-up window is obtained, relevant operations of obtaining the relevant data of the user start to be performed. Otherwise (e.g., when a confirmation operation of the user for the prompt interface or the pop-up window is not obtained), relevant operations of obtaining the relevant data of the user are ended, e.g., the relevant data of the user is not obtained. e.g., all user data acquired in the present disclosure is acquired with user consent and authorization, and collection, use, and processing of relevant user data need to comply with relevant laws, regulations, and standards of relevant regions.

Before the technical solutions of the present disclosure are described, some terms used in the present disclosure are first explained and described. The following related explanations may be freely combined with the technical solutions of some embodiments of the present disclosure as exemplary solutions, and shall fall within the protection scope of some embodiments of the present disclosure. Some embodiments of the present disclosure include at least a part of the following content.

An information feed is a data form in which social content is continuously updated and presented to a user. The information feed includes at least a timeline-based presentation form and a random presentation form. The timeline-based presentation form means presenting the social content to the user in a chronological order of updating the content of the information feed. The random presentation form means calculating a weight of the content based on some factors, to determine a presentation sequence of the social content. For example, a weight of social content published by a subscription account is calculated based on an algorithm, and a sequence of recommending the social content published by the subscription account to the user is determined based on the weight. Alternatively, the information feed uses a different representation form to present the social content, and a common representation form is, for example, a list form, a waterfall form, or a card form. Alternatively, the information feed may be considered as an aggregation of at least one resource provided by at least one content source a user account subscribes to.

Artificial intelligence (AI) is a theory, method, technology, and application system of simulating, extending, and developing human intelligence by using a digital computer or a machine controlled by a digital computer to perceive an environment, acquire knowledge, and obtain an optimal result by using the knowledge. For example, artificial intelligence is a comprehensive technology in computer science, and attempts to understand essence of intelligence and produce a new intelligent machine that can react in a manner similar to human intelligence. Artificial intelligence is to research design principles and implementation methods of various intelligent machines, so that the machines have functions of perception, reasoning, and decision-making.

Augmented reality (AR) is a technology that combines virtual information with a real world, and creates augmented reality experience by superimposing the virtual information onto the real world. AR can capture an image and sound in the real world via a camera, a sensor, and another device, and combine the information with virtual content generated by a computer, to enhance sensory experience of a user.

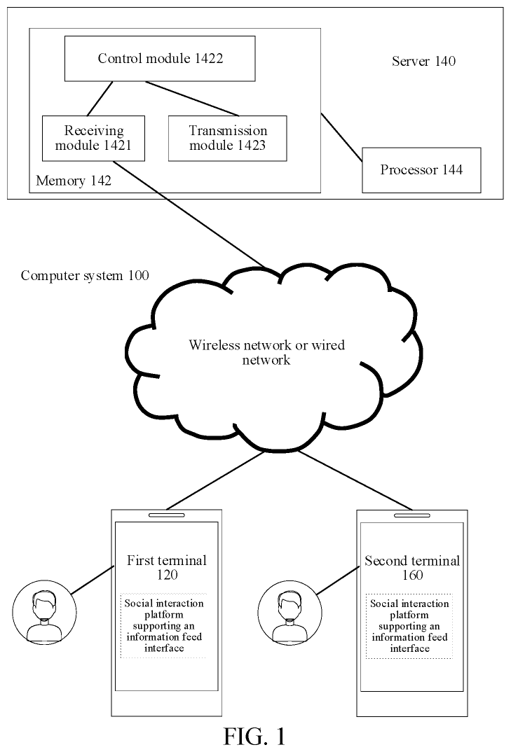

FIG. 1 is a block diagram of a structure of a computer system according to some embodiments of the present disclosure. The computer system 100 includes a first terminal 120, a server 140, and a second terminal 160.

A social interaction platform supporting an information feed interface is installed and run on the first terminal 120. A first user account logs in to the social interaction platform. The first user account may browse or publish content on the information feed interface of the social interaction platform. The first user account may further interact with a subscription account of the social interaction platform by using the information feed interface presented on the social interaction platform. An example in which the social interaction platform is a social feed of a social application is used, and the first user account may like and comment on social content published by a friend account of the first user account. An example in which the social interaction platform is a question-answer community is used, and the first user account may perform operations such as agreeing, commenting, sharing, reporting, or blocking on content published by a user account followed by the first user account.

The social interaction platform supporting an information feed interface is installed and run on the second terminal 160. A second user account logs in to the social interaction platform. The second user account may browse or publish content on the information feed interface of the social interaction platform. The second user account may further interact with a subscription account of the social interaction platform by using the information feed interface presented on the social interaction platform.

In some embodiments, there is a unidirectional subscription relationship between the first user account and the second user account. If the second user account publishes social content on the social interaction platform, the first user account can browse the content on the information flow interface. However, if the first user account publishes social content on the social interaction platform, the second user account cannot browse the content on the information flow interface.

In some embodiments, there is a bidirectional subscription relationship between the first user account and the second user account. If the second user account publishes social content on the social interaction platform, the first user account can browse the content on the information flow interface. In addition, if the first user account publishes social content on the social interaction platform, the second user account can browse the content on the information flow interface.

The first terminal 120 and the second terminal 160 are connected to the server 140 over a wireless network or a wired network.

The server 140 includes at least one of one server, a plurality of servers, a cloud computing platform, and a virtualization center. For example, the server 140 includes a processor 144 and a memory 142. The memory 142 further includes a receiving module 1421, a control module 1422, and a transmission module 1423. The receiving module 1421 is configured to receive a request transmitted by the social interaction platform, for example, a request for liking target social content. The control module 1422 is configured to control rendering of the information feed interface. The transmission module 1423 is configured to transmit a response to the social interaction platform, for example, transmit a feedback indicating whether liking succeeds to the social interaction platform. The server 140 is configured to provide a backend service to support the social interaction platform. In some embodiments, the server 140 undertakes primary computing works of a function supported by the social interaction platform, and the first terminal 120 and the second terminal 160 undertake secondary computing works of the function supported by the social interaction platform. Alternatively, the server 140 undertakes secondary computing works of a function supported by the social interaction platform, and the first terminal 120 and the second terminal 160 undertake primary computing works of the function supported by the social interaction platform. Alternatively, the server 140, the first terminal 120, and the second terminal 160 collaboratively undertake computing works of a function supported by the social interaction platform.

In some embodiments, device types of the first terminal 120 and the second terminal 160 are the same or different. The device type includes at least one of a smartphone, a smartwatch, an in-vehicle terminal, a wearable device, a smart television, a tablet computer, an e-book reader, an MP3 player, an MP4 player, a laptop computer, and a desktop computer. In the following embodiments, an example in which a terminal includes a smartphone is used for description.

A person skilled in the art may understand that more or fewer terminals may be provided. For example, there may be only one terminal, or there are dozens of, hundreds of, or more terminals. A quantity and device types of terminals are not limited in the embodiments of the present disclosure.

One or more components of FIG. 1 may be integrated into a single component, or conversely, a single component may be implemented as multiple discrete elements. Additionally or alternatively, different subsets of the illustrated components may be combined in various configurations.

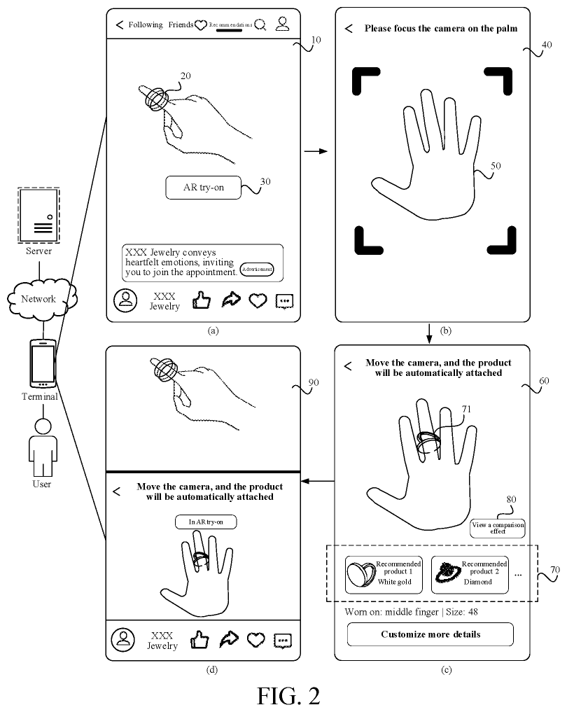

For example, FIG. 2 is a schematic diagram of a recommendation-based interaction method according to some embodiments of the present disclosure.

In a related technology, an example in which the recommended product is an accessory is used. When a user browses a short video, the accessory is mostly presented in the short video in a form of a static picture or a dynamic video. The user learns a try-on effect of the accessory from the presented static picture or dynamic video, and makes a decision for further understanding or purchase by estimating or referring to a try-on effect of another person. For example, the user may select to further tap an interactive control in the short video to enter a details interface corresponding to the accessory. However, in the related technology, a presentation effect of the recommended product is limited, and an interaction mode between the user and the recommended product is relatively simple, resulting in a low click-through rate of the recommended product.

In view of the foregoing problem, some embodiments of the present disclosure provides a recommendation-based interaction method. An information feed advertisement corresponding to a first recommended product is displayed on an information feed interface (for example, a short video playback interface). For example, the information feed advertisement is a recommendation short video. In some embodiments, the short video playback interface further includes a virtual interactive control. After the user taps the virtual interactive control, a terminal device obtains a target object image of the user, for example, obtains a hand image of the user, via a camera, and analyzes the hand image of the user, for example, analyzes a size and a shape of the hand image, based on an AI algorithm, to obtain a recommendation list for the hand image. The recommendation list includes at least one recommended product belonging to a same type as the first recommended product. A try-on effect of the target recommended product superimposed on a hand of the user is displayed on a virtual trial interface. The user can view the try-on effect from different angles by moving the hand.

For example, a social interaction platform is installed and run on the terminal device. For example, an example in which a recommendation medium of the first recommended product is the recommendation short video is used for description. The social interaction platform is designed with a short video playback interface 10. The short video playback interface 10 includes social content that is published by at least one content publishing account and that is arranged by time. The content publishing account is an account for publishing social content on the social interaction platform. As shown in (a) in FIG. 2, the content publishing account is an advertisement account. For example, the content publishing account is “XXX Jewelry”, and the social content published by the content publishing account is advertisement content.

In some embodiments, a recommendation short video of a first recommended product 20 and a virtual interactive control 30 are displayed on the short video playback interface 10. The first recommended product 20 may be an accessory, for example, a ring, a bracelet, or a necklace. Alternatively, the first recommended product 20 may be a makeup product, for example, a lipstick, an eye shadow, or an eyebrow pencil. The virtual interactive control 30 is an interactive element on the short video playback interface 10 that is configured for triggering AR try-on. In some embodiments, the virtual interactive control 30 is usually presented in a form of an icon, a button, a text, or the like.

In some embodiments, a camera capture preview interface 40 is displayed based on a trigger operation on the virtual interactive control 30. In some embodiments, prompt information configured for guiding capture of the target object image is displayed on the camera capture preview interface 40. For example, the prompt information is a guidance mask 50. For example, as shown in (b) in FIG. 2, after the user taps the virtual interactive control 30, the camera capture preview interface 40 and the guidance mask 50 corresponding to the camera capture preview interface 40 are displayed. The guidance mask 50 is configured for guiding the user to capture the target object image. The target object image is an image of a body part of the user. In some embodiments, the target object image is an image of a body part for applying a makeup color or wearing an accessory. For example, the target object image is a hand image of the user, the target object image is a neck image of the user, or the target object image is a lip image of the user. In some embodiments, the user controls, under a guidance of the guidance mask 50, the target object image to be aligned with the guidance mask 50 within the camera capture preview interface 40.

As shown in FIG. (c) in FIG. 2, an associated effect of a physical attribute corresponding to a target recommended product 71 on a target part in the target object image is displayed based on the target object image satisfying a capture condition, e.g., based on an overlap degree between the target object image and the guidance mask 50 satisfying a first threshold. The associated effect is a virtual product effect of the target recommended product 71. A virtual trial interface 60 is displayed, on which the target recommended product 71 is superimposed and displayed on the target part in an AR form. The overlap degree is a spatial overlapping degree (or overlapping ratio) between the target object image and the guidance mask. The overlap degree may be configured for measuring consistency between the target part and the guidance mask. If the overlap degree reaches or exceeds the preset first threshold, the target recommended product 71 is superimposed and displayed on the target part in an AR form.

In some embodiments, the target recommended product 71 is the first recommended product 20, or the target recommended product 71 is a second recommended product belonging to a same type as the first recommended product 20. The same type means that the recommended products belong to a same category or class. For example, the first recommended product is a ring, and the target recommended product is also a ring. In some embodiments, the target recommended product 71 is a recommended product obtained by analyzing the target object image of the user based on the AI algorithm.

In some embodiments, the target object image is analyzed based on the AI algorithm based on the overlap degree between the target object image and the guidance mask 50 satisfying the first threshold, to obtain a recommendation list 70. For example, as shown in (c) in FIG. 2, the recommendation list 70 includes at least one candidate recommended product.

In some embodiments, at least one candidate recommended product in the recommendation list 70 is sorted in descending order of fitness with the target object image, and the first-ranked candidate recommended product is determined as the target recommended product 71, and is superimposed and displayed on the target part in an AR form.

In some embodiments, the recommendation list 70 is obtained by analyzing, based on the AI algorithm, a reference standard corresponding to the target object image. Different target object images correspond to different reference standards. For example, when the target object image is a hand image, a reference standard corresponding to the hand image includes but is not limited to at least one of a shape, a size, and a color of the hand. When the target object image is a neck image, a reference standard corresponding to the neck image includes but is not limited to at least one of a color and smoothness of the neck.

In some embodiments, based on a selection operation on any candidate recommended product in the recommendation list 70, the selected candidate recommended product is superimposed and displayed on the target part in an AR form. In some embodiments, the user browses the recommendation list 70, and selects a candidate recommended product in the recommendation list 70 based on a preference of the user.

In some embodiments, the associated effect of the physical attribute corresponding to the target recommended product 71 on the target part is updated based on an interactive operation on the target recommended product 71. In some embodiments, an angle of the target recommended product 71 is rotated based on a rotation operation on the target recommended product 71, and the rotated target recommended product 71 is displayed on the target part. Alternatively, the target recommended product 71 is zoomed in, based on a zoom-in operation on the target recommended product 71, and the zoomed-in target recommended product 71 is displayed on the target part. Alternatively, the target recommended product 71 is zoomed out based on a zoom-out operation on the target recommended product 71, the zoomed-out target recommended product 71 is displayed on the target part. Alternatively, the target recommended product 71 is moved based on a movement operation on the target recommended product 71, and the moved target recommended product 71 is displayed on the target part. The user can view wearing effects of the target recommended product 71 in different states through the rotation operation, the zoom-in operation, the zoom-out operation, and the movement operation on the target recommended product 71.

In some embodiments, the user may move the target part to superimpose and display, based on a movement operation on the target part, the target recommended product 71 on the target part in an AR form based on different angles. In some embodiments, the target recommended product 71 is superimposed and displayed on the target part in an AR form in different scenarios based on a switching operation on a virtual background. Switching the virtual background can simulate wearing effects of the user in different daily scenarios.

In some embodiments, as shown in (c) in FIG. 2, the virtual trial interface 60 includes a split-screen control 80, and the split-screen control 80 is configured for triggering split-screen display of the virtual trial interface 60. The virtual trial interface 60 is an interface displaying the associated effect of the physical attribute corresponding to the target recommended product 71 on the target part. The virtual trial interface 60 and the short video playback interface 10 are controlled to be displayed on a comparison interface 90 in a split-screen form based on a trigger operation on the split-screen control 80. The user can view a wearing difference between an advertised effect and an actual effect by using the comparison interface 90.

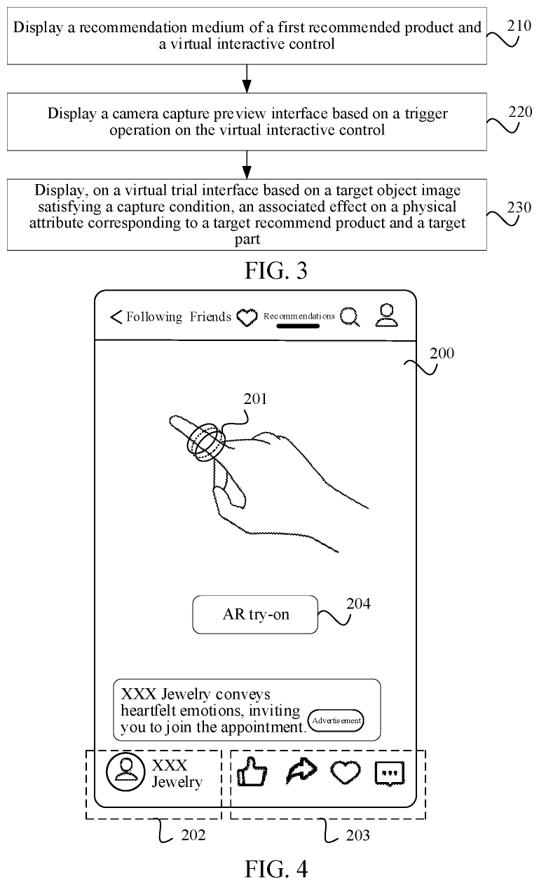

FIG. 3 is a flowchart of a recommendation-based interaction method according to some embodiments of the present disclosure. The method may be performed by a terminal device, may be performed by a server, or may be jointly performed by a terminal device and a server. The method includes at least the following operations.

In the some embodiments, operations may be performed sequentially, in a different order, in parallel, or with some operations skipped or repeated.

Operation 210: Display a recommendation medium of a first recommended product and a virtual interactive control.

The recommendation medium is a manner for presenting the first recommended product. The recommendation medium has a plurality of different forms. In some embodiments, the recommendation medium includes but is not limited to at least one of a recommendation short video, recommendation text content, a recommendation website, a recommendation official account, a recommendation mini program, and a recommendation mobile application.

For example, the recommendation medium is the recommendation mini program. In some embodiments, a social interaction platform is installed and run on the terminal device. The recommendation mini program is installed inside the social interaction platform. After the recommendation mini program is entered, the virtual interactive control corresponding to the first recommended product is displayed on a home page. A player may trigger the virtual interactive control to interact with the first recommended product.

For example, the recommendation medium is the recommendation text content. In some embodiments, a target application is installed and run on the terminal device, and the target application supports display of the recommendation text content. In some embodiments, the text content includes a promotion keyword, and the promotion keyword is interactive text content. To be specific, the promotion keyword may be the virtual interactive control. A player may trigger the promotion key word (the virtual interactive control) to interact with the first recommended product.

For example, the recommendation medium is the recommendation short video. In some embodiments, a social interaction platform is installed and run on the terminal device, the social interaction platform is designed with a short video playback interface, and the short video playback interface is an information feed interface. In some embodiments, the virtual interactive control corresponding to the first recommended product is displayed on the short video playback interface. A player may trigger the virtual interactive control to interact with the first recommended product. This is not limited in the present disclosure.

Some embodiments of the present disclosure is described mainly by using the recommendation short video as the recommendation medium. However, this does not constitute a limitation on the recommendation medium.

In some embodiments, the recommendation medium is the recommendation short video, the recommendation short video is displayed on the short video playback interface, and the short video playback interface is an information feed interface. The information feed interface is an interface on which content is continuously updated and presented to a user. The information feed interface includes social content transmitted by at least one content publishing account. An information feed includes at least a timeline-based presentation form and a random presentation form. In some embodiments, the information feed interface includes the social content that is transmitted by the at least one content publishing account and that is arranged by time. Alternatively, the information feed interface includes the social content that is transmitted by the at least one content publishing account and that is randomly presented.

In some embodiments, the content publishing account is an account for publishing social content on the social interaction platform. The social content is content published by the content publishing account. If the content publishing account is a user account, the social content may be a daily post, a forwarded video, or the like published by the user account.

In some embodiments, the content publishing account is an advertisement account, and social content published by the advertisement account is an information feed advertisement corresponding to the first recommended product. In some embodiments, the information feed advertisement is displayed on the short video playback interface in a form of a short video or in a form of a picture.

In some embodiments, the recommendation short video of the first recommended product and the virtual interactive control are displayed on the short video playback interface. The first recommended product may be an accessory product, for example, a ring, a bracelet, or a necklace. Alternatively, the first recommended product may be a makeup product, for example, a lipstick, an eye shadow, or an eyebrow pencil. The virtual interactive control is an interactive element on the short video playback interface that is configured for triggering AR interaction. In some embodiments, the virtual interactive control is usually presented in a form of an icon, a button, a text, or the like.

In some embodiments, the content publishing account is an advertisement account, and the first recommended product is promotion content corresponding to the advertisement account. In some embodiments, a promotion slogan corresponding to the first recommended product is further displayed on the short video playback interface. In some embodiments, the short video playback interface further includes a reaction component for the first recommended product. The reaction component includes but is not limited to at least one of a like button, a comment button, a favorites button, and a forward button.

For example, as shown in FIG. 4, the social interaction platform is installed and run on the terminal device. The social interaction platform displays a short video playback interface 200. The short video playback interface 200 includes social content published by at least one content publishing account 202. For example, the content publishing account 202 is an advertisement account “XXX Jewelry”. The social content published by the content publishing account 202 is promotion content. For example, the promotion content published by the content publishing account 202 is a recommendation short video of a first recommended product 201. The first recommended product 201 is an accessory product, for example, a ring. A reaction component 203 is further displayed around the content publishing account 202, and the user may react to the recommendation short video of the first recommended product 201 based on the reaction component 203. In some embodiments, a virtual interactive control 204 is further displayed on the short video playback interface, and the virtual interactive control 204 is displayed as “AR try-on”.

Operation 220: Display a camera capture preview interface based on a trigger operation on the virtual interactive control.

The trigger operation on the virtual interactive control includes at least one of a direct trigger operation and an indirect trigger operation.

In some embodiments, the direct trigger operation on the virtual interactive control includes but is not limited to a tap operation, a double-tap operation, a voice operation, a touch-and-hold operation, a slide operation, a touch operation, a key operation, a gesture operation, or any combination of at least two of the foregoing operations.

In some embodiments, the indirect trigger operation on the virtual interactive control may be implemented by using the reaction component. In some embodiments, the short video playback interface further includes the reaction component for the recommendation short video for the first recommended product. The reaction component includes but is not limited to at least one of the like button, the comment button, the favorites button, and the forward button.

In some embodiments, based on a positive reaction operation on the reaction component, it is determined that a condition of the indirect trigger operation on the virtual interactive control is satisfied. The positive reaction operation is an operation through which the user performs positive interaction on expresses a favorable attitude for the recommendation short video by using the reaction component. In some embodiments, the positive reaction operation may be a like operation, a favorites operation, a forward operation, or a comment operation on the recommendation short video. After the user performs the positive reaction operation, it is determined that the condition of the indirect trigger operation on the virtual interactive control is satisfied. A positive feedback of the user for the recommendation short video of the first recommended product affects a status of the virtual interactive control. For example, after the user performs the like operation on the like button in the reaction component, the like operation represents the positive feedback of the user for the recommendation short video of the first recommended product. Based on the positive reaction operation, the terminal device triggers the virtual interactive control on the short video playback interface, and displays or presents the virtual interactive control automatically.

In some embodiments, the camera capture preview interface is displayed based on the trigger operation on the virtual interactive control, the camera capture preview interface including prompt information configured for guiding capture of a target object image. In some embodiments, after the virtual interactive control is directly triggered or indirectly triggered, a display interface of the terminal device navigates from the short video playback interface to the camera capture preview interface.

The camera capture preview interface is a frame obtained in real time by the user through photographing with the camera of the terminal device. The camera capture preview interface allows the user to view, in real time, an image captured by the camera. The prompt information is instructive information or a visual auxiliary element presented to the user on the camera capture preview interface. The prompt information is configured for showing the user how to capture the target object image on the camera capture preview interface based on the camera. In some embodiments, the target object image includes a body part image and a non-body part image.

In some embodiments, the target object image is a body part image (or referred to as a target try-on part image). The first recommended product is a product that acts on a target part. In this case, the target part is a body part. In some embodiments, the first recommended product is an accessory product or a makeup product for modifying the body part of the user. On the camera capture preview interface, the camera is moved based on an interaction manner indicated by the prompt information, so that the camera can obtain an image corresponding to the body part. For example, the first recommended product is a ring, and the pre-captured target object image is a hand image. For another example, the first recommended product is a necklace, and the pre-captured target object image is a neck image. For another example, the first recommended product is lipstick, and the pre-captured target object image is a lip image.

In some embodiments, the target object image is a non-body part image (or referred to as a target spatial location image). The first recommended product is a product that acts on the target part. In this case, the target part is a target spatial location. In some embodiments, the first recommended product is a decorative product or a practical product. On the camera capture preview interface, the camera is moved based on an interaction manner indicated by the prompt information, so that the camera can obtain an image corresponding to the target spatial location. The target spatial location is a location related to an action location of the first recommended product. For example, the first recommended product is a television, and the pre-captured target object image (target spatial location image) is an image corresponding to a regional location at which the television is placed, for example, an image of a location of a television cabinet. For another example, the first recommended product is a decoration, and the pre-captured target object image (target spatial location image) is an image corresponding to a regional location at which the decoration is placed, for example, an image of a blank wall location at which the decoration is hung. For another example, the first recommended product is a lamp, and the pre-captured target object image (target spatial location image) is an image corresponding to a regional location requiring lighting, for example, an image of a bookshelf location at which the lamp needs to be placed.

In some embodiments, the prompt information is the instructive information or the visual auxiliary element presented to the user on the camera capture preview interface. In some embodiments, the prompt information is a guidance mask. The guidance mask may be a layer that covers the camera capture preview interface and that has a specific shape and/or color. For example, the guidance mask is a layer that covers the camera capture preview interface and that uses a preset transparency. Alternatively, the guidance mask is a layer that covers the camera capture preview interface and that uses a preset color (for example, white or black). Alternatively, the guidance mask is a layer that covers the camera capture preview interface and that has a preset shape (for example, a hand shape). The guidance mask is configured for guiding the user to capture the target object image.

In some embodiments, when the target object image is a body part image, the prompt information is a first-type guidance mask. A shape of the first-type guidance mask is related to a shape of the pre-captured target object image. For example, the first recommended product is a ring, the pre-captured target object image is a hand image, and the guidance mask is displayed as a palm-shaped layer. For another example, the first recommended product is a necklace, the pre-captured target object image is a neck image, and the guidance mask is displayed as a neck-shaped layer. This is not limited in the present disclosure.

In some embodiments, when the target object image is a non-body part image, the prompt information is a second-type guidance mask. A shape of the second-type guidance mask is related to a regional location at which the first recommended product is placed. For example, the first recommended product is a television, the pre-captured target object image is an image corresponding to a regional location at which the television is placed, and the guidance mask may be displayed as a layer in a shape of a television cabinet. For another example, the first recommended product is a lamp, the pre-captured target object image is an image corresponding to a regional location requiring lighting, and the guidance mask may be displayed as a desk-shaped layer. This is not limited in the present disclosure.

In some embodiments, the camera capture preview interface includes a capture box, and the guidance mask is displayed in the capture box. The capture box is located in a target region on the camera capture preview interface. A display form of the capture box is a rectangular frame form, a circular frame form, or a frame form of another shape. The target region is a display region of the capture box. The target region may be a preset region or a dynamically changing region. For example, the target region is a middle two-thirds region of a terminal screen. In some embodiments, a display size of the capture box may change dynamically. In some embodiments, the display size of the capture box changes with a distance between a target object and the camera. For example, a larger distance between the target object and the camera indicates a smaller display size of the capture box, and a smaller distance between the target object and the camera indicates a larger display size of the capture box.

In some embodiments, the camera capture preview interface further includes capture prompt information. The capture prompt information is prompt information configured for guiding the target object image to a location of the guidance mask. In some embodiments, a type of the capture prompt information includes but is not limited to at least one of text prompt information, arrow prompt information, image prompt information, and voice prompt information. In some embodiments, the capture prompt information is located at a peripheral location of the capture box, for example, at a location above the capture box. In some embodiments, display information of the capture prompt information may change dynamically.

In a possible implementation, the capture prompt information is the voice prompt information, and the voice prompt information may change with a location change of the target object relative to the camera. For example, the target object image is a hand image. At the beginning, the voice prompt information is “Please put your hand in the capture box at the center of the screen”. When the hand of the user is not aligned with the guidance mask, the voice prompt information is “Your hand slightly deviates from the center, please move to the left”.

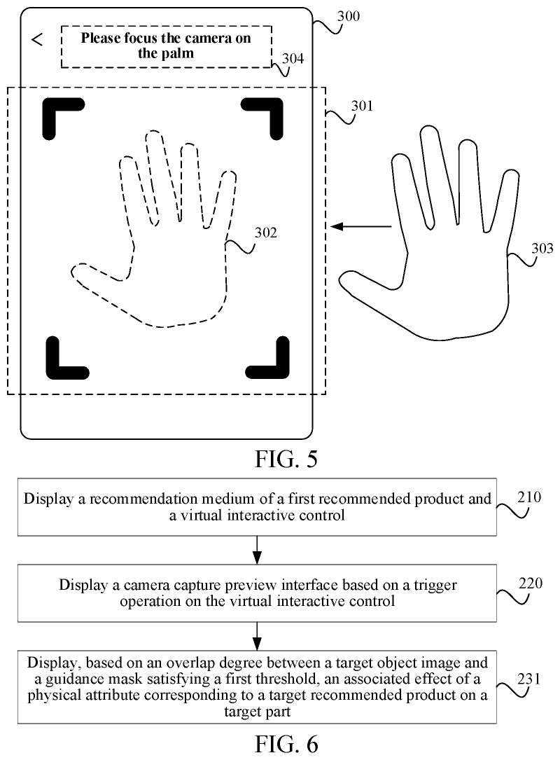

For example, as shown in FIG. 5, a camera capture preview interface 300 is displayed based on the trigger operation on the virtual interactive control, for example, a tap operation on the virtual interactive control. A capture box 301 is displayed on the camera capture preview interface 300. The capture box 301 is located in a preset region on the camera capture preview interface 300. A guidance mask 302 is located in the capture box 301. A shape of the guidance mask 302 is related to a shape of a pre-captured target object image 303. For example, the first recommended product is a ring, the pre-captured target object image 303 is a hand image of the user, and the shape of the guidance mask 302 is a palm shape. In some embodiments, the guidance mask 302 is configured for guiding the user to capture the target object image 303. Capture prompt information 304 is further displayed at a location above the capture box 301. The capture prompt information 304 is text prompt information, for example, text prompt information “Please focus the camera on the palm”.

Operation 230: Display, on a virtual trial interface based on the target object image satisfying a capture condition, an associated effect of a physical attribute corresponding to a target recommended product on the target part.

The capture condition is a condition that needs to be satisfied by the camera of the terminal device when capturing the target object image.

In some embodiments, after the target object image recognized in a camera preview frame satisfies the capture condition, the interface switches or navigates from the camera capture preview interface to the virtual trial interface, and the associated effect of the physical attribute corresponding to the target recommended product on the target part is displayed on the virtual trial interface. The virtual trial interface is an interface for displaying the associated effect of the physical attribute corresponding to the target recommended product on the target part. After the target object image recognized in the camera preview frame satisfies the capture condition, the interface switches or navigates from the camera capture preview interface to the virtual trial interface. The target recommended product is the first recommended product or a second recommended product belonging to a same type as the first recommended product. The same type means that the recommended products belong to a same category or class. For example, the first recommended product is a ring, and the target recommended product is also a ring. For another example, the first recommended product is a bracelet, and the target recommended product is also a bracelet.

The associated effect is a visual effect or an application effect generated when the physical attribute of the target recommended product is combined with the target part. In some embodiments, the associated effect acting on the target part is a virtual product effect, e.g., a virtual product effect of the target recommended product displayed on the target part in an AR form.

Displaying the target recommended product on the target part in an AR form means naturally fusing the virtual target recommended product to a real scenario (e.g., the target object image captured by the camera) by using an AR technology, so that the target recommended product and the target part in the target object image can be naturally fused. For example, the terminal device or the server may render a three-dimensional (3D) model of the target recommended product to the target part in the target object image by using a 3D rendering technology. During 3D rendering, the terminal device or the server considers lighting consistency of the real scenario and an occlusion relationship between the target recommended product and the target part, so that a rendering result is more realistic.

The target part is a location in the target object image that is related to the action location of the first recommended product, and may be a body part or a target spatial location. For example, when the target object image is a body part image, the first recommended product is an accessory product or a makeup product for modifying a body part of the user, and correspondingly, the target part is a location at which the first recommended product is worn or an action location of the makeup product in the body part image. For example, when the body part image is a hand image, the target part may be a finger for wearing a ring in the hand image. When the body part image is a face image, the target part may be a lip location for applying a lipstick in the face image.

When the target object image is a non-body part image, the first recommended product is a decorative product or a practical product, and correspondingly, the target part is a location for placing or mounting the first recommended product in the non-body part image. For example, when the target object image is a television cabinet image or a partial living room image, the target part is a location for placing a television in the television cabinet image or the partial living room image. The partial living room image includes the television cabinet image, and may further include a partial image of a table, a fish tank, or the like adjacent to a television cabinet.

In some embodiments, the target object image is a body part image (or referred to as a target try-on part image), and the first recommended product is a product acting on a body part. In some embodiments, the first recommended product is an accessory product or a makeup product for modifying the body part of the user. The target recommended product is the first recommended product or the second recommended product belonging to the same type as the first recommended product. For example, the target recommended product is an accessory product or a makeup product for modifying the body part of the user. The physical attribute corresponding to the target recommended product is a decoration effect of the accessory product or the makeup product. For example, the target recommended product is a lipstick, and a physical attribute of the lipstick is a makeup modification effect acting on a lip of the user. For another example, the target recommended product is a ring, and a physical attribute of the ring is an accessory decoration effect acting on a finger of the user. In some embodiments, the associated effect of the physical attribute corresponding to the target recommended product on the target part is displayed, e.g., a virtual product effect of the target recommended product being superimposed and displayed on the body part of the user in an AR form is displayed.

In some embodiments, the target object image is a non-body part image (or referred to as an image corresponding to a target spatial location), and the first recommended product is a product acting on the target spatial location. In some embodiments, the first recommended product is a decorative product or a practical product. The target recommended product is the first recommended product or the second recommended product belonging to the same type as the first recommended product. For example, the target recommended product is a decorative product or a practical product. The physical attribute corresponding to the target recommended product is an actual physical feature such as a size and a material of the decorative product or the practical product. For example, the target recommended product is a television, and a physical attribute corresponding to the television includes a size (a length, a width, and a height) of the television. For another example, the target recommended product is a sofa, and a physical attribute corresponding to the sofa includes a material of the sofa (for example, a leather sofa or a velvet sofa). In some embodiments, the associated effect of the physical attribute corresponding to the target recommended product on the target part is displayed, e.g., a virtual product effect of the target recommended product being placed and displayed at the target spatial location in an AR form is displayed.

The foregoing capture condition defaults to satisfy an environmental condition, for example, satisfy environmental conditions such as a lighting condition, background interference, and an image resolution.

In a related technology, when browsing a short video, the user learns a try-on effect of a recommended product from a presented static picture or dynamic video. In Some embodiments of the present disclosure, when the recommendation medium is the recommendation short video, the first recommended product and the virtual interactive control are displayed on the short video playback interface, so that the user may trigger the virtual interactive control to enter the camera capture preview interface, and interact on the camera capture preview interface based on the prompt information. After the target object image satisfies the capture condition, the associated effect of the physical attribute corresponding to the target recommended product on the target part in the target object image is displayed on the virtual trial interface. For example, an AR interaction mode is entered based on the prompt information, the virtual product effect of the target recommended product is previewed through AR, and the virtual product effect of the target recommended product is displayed (superimposed and displayed when the target part is the body part, or placed and displayed when the target part is the target spatial location) on the target part in an AR form, ensuring fusion of the virtual product effect of the target recommended product and the real scenario. Further, a same product as the recommended product (the first recommended product) or a product of a similar type is recommended to the user through the trigger operation on the virtual interactive control, implementing a personalized recommendation service. Such a recommendation manner not only improves recommendation accuracy, but also increases an interaction frequency between the user and the information feed advertisement, improving a click-through rate of the information feed advertisement.

An overlap degree between the target object image and the guidance mask satisfies the capture condition.

In some embodiments, the prompt information is the guidance mask. The guidance mask is configured for guiding capture of the target object image. The associated effect of the physical attribute corresponding to the target recommended product on the target part is displayed based on the target object image satisfying the capture condition. In some embodiments, the capture condition includes the overlap degree. When the overlap degree between the target object image and the guidance mask satisfies the capture condition, the associated effect of the physical attribute corresponding to the target recommended product on the target part is displayed.

FIG. 6 is a flowchart of a recommendation-based interaction method according to some embodiments of the present disclosure. Operation 230 may be replaced with operation 231.

In the some embodiments, operations may be performed sequentially, in a different order, in parallel, or with some operations skipped or repeated.

Operation 231: Display, based on the overlap degree between the target object image and the guidance mask satisfying a first threshold, the associated effect of the physical attribute corresponding to the target recommended product on the target part.

The overlap degree is an overlapping degree between the target object image and the guidance mask. The overlapping degree is a spatial overlapping degree between the target object image and the guidance mask. The overlap degree is configured for measuring a matching degree between the target part and the guidance mask. If the overlap degree reaches or exceeds the preset first threshold, the associated effect of the physical attribute corresponding to the target recommended product on the target part is displayed.

In some embodiments, the associated effect is a visual effect or an application effect generated when the physical attribute of the target recommended product is combined with the target part. In some embodiments, the associated effect acting on the target part is a virtual product effect, e.g., a virtual product effect of the target recommended product displayed on the target part in an AR form.

For example, the target recommended product is an accessory product, for example, a ring. When the overlap degree between the target object image and the guidance mask needs to satisfy the first threshold, e.g., meet a minimum overlap degree requirement, a virtual product effect of the ring is superimposed and displayed on a body part, for example, a finger part, of the user in an AR form.

For example, the target recommended product is a practical product, for example, a sofa. When the overlap degree between the target object image and the guidance mask needs to satisfy the first threshold, e.g., meet a minimum overlap degree requirement, a virtual product effect of the sofa is placed and displayed at a target spatial location, for example, a regional location of a living room, in an AR form.

In some embodiments, the overlap degree between the target object image and the guidance mask needs to satisfy the first threshold. The first threshold is represented as a percentage of the overlap degree, and indicates the minimum overlap degree requirement. For example, the first threshold is set to 80%. When the overlap degree between the target object image and the guidance mask reaches or exceeds 80%, it may be considered that the target object image has been correctly placed at a specified location (a location of the guidance mask) on the camera capture preview interface, e.g., the target object image and the guidance mask have been correctly aligned. In this case, the associated effect of the physical attribute corresponding to the target recommended product on the target part is displayed, e.g., the virtual product effect of the target recommended product is displayed on the target part in an AR form.

In some embodiments, the overlap degree is configured for indicating a degree of overlapping between an area of the target object image on the camera capture preview interface and an area occupied by the guidance mask.

In some embodiments, an overlapping region between the target object image and the guidance mask is displayed in a first display style, and a non-overlapping region between the target object image and the guidance mask is displayed in a second display style. In some embodiments, the first display style is different from the second display style, and visual prominence of the first display style is higher than that of the second display style. The display style includes but is not limited to at least one of display brightness, display transparency, a display color, a display effect, and a display line.

In some embodiments, that the visual prominence of the first display style is higher than that of the second display style may be manifested in the following aspects.
The display style is presented as the display brightness: Display brightness of the overlapping region is different from that of the non-overlapping region. For example, the display brightness of the overlapping region is higher than that of the non-overlapping region. In some embodiments, brightness or contrast of the overlapping region between the target object image and the guidance mask is improved, so that the overlapping region is more prominent on the camera capture preview interface. In this manner, the overlapping region and the non-overlapping region can be significantly distinguished.
The display style is presented as the display transparency: Display transparency of the overlapping region is different from that of the non-overlapping region. For example, the display transparency of the overlapping region is higher than that of the non-overlapping region. In some embodiments, the display transparency of the overlapping region between the target object image and the guidance mask is set to be higher than that of the non-overlapping region. For example, the transparency of the overlapping region is set to 100%, e.g., the overlapping region is fully transparent, and the transparency of the non-overlapping region is set to 0%, e.g., the non-overlapping region is fully opaque. In this manner, the overlapping region and the non-overlapping region can be significantly distinguished.
The display style is presented as the display color: A display color of the overlapping region is different from that of the non-overlapping region. For example, the display color of the overlapping region is brighter than that of the non-overlapping region. In some embodiments, the display color of the overlapping region between the target object image and the guidance mask is set to be brighter than that of the non-overlapping region. For example, the overlapping region is displayed in a bright color, and the non-overlapping region is displayed in a dark color. In this manner, the overlapping region and the non-overlapping region can be significantly distinguished.
The display style is presented as the display effect: A display effect of the overlapping region is different from that of the non-overlapping region. For example, the display effect of the overlapping region is more abundant than that of the non-overlapping region. In some embodiments, the display effect of the overlapping region between the target object image and the guidance mask is set to be richer than that of the non-overlapping region. For example, the overlapping region is displayed with a floating effect, and the non-overlapping region is displayed statically. In this manner, the overlapping region and the non-overlapping region can be significantly distinguished.
The display style is presented as the display line: A display line of the overlapping region is different from that of the non-overlapping region. For example, the display line of the overlapping region is thicker than that of the non-overlapping region. In some embodiments, the display line of the overlapping region between the target object image and the guidance mask is set to be thicker than that of the non-overlapping region. For example, an edge line of the overlapping region is displayed as a thick line, and an edge line of the non-overlapping region is displayed as a thin line. In this manner, the overlapping region and the non-overlapping region can be significantly distinguished.

The foregoing is merely examples for description, and does not constitute a limitation on the display styles of the overlapping region and the non-overlapping region. In some embodiments, the display style may be any one of the foregoing display styles, or any combination of at least two display styles. This is not limited in the present disclosure.

In some embodiments, the overlap degree is configured for indicating a degree of overlapping between an area of the target object image on the camera capture preview interface and an area occupied by the guidance mask. The terminal device first captures the target object image of the user, for example, a hand image of the user, based on the camera; then identifies and positions an edge feature point of the target object image based on edge detection, extracts the edge feature point of the target object image, and aligns the edge feature point of the target object image with an edge feature point in the guidance mask, to determine a relative location of the target object image and the guidance mask; and then calculates the area of the target object image by using the edge feature point of the target object image, overlaps the area of the target object image and the area of the guidance mask, calculates an overlapping area between the target object image and the guidance mask, and obtains the overlap degree between the target object image and the guidance mask based on the overlapping area. For example, a ratio of the overlapping area to a total image area is calculated to obtain the overlap degree between the target object image and the guidance mask. The total image area is a union of the area of the target object image and the area of the guidance mask. The overlapping area may be understood as an intersection of the area of the target object image and the area of the guidance mask.

In some embodiments, the overlap degree may be represented as a percentage or another metric value (for example, a decimal). The percentage is used as an example. A value of the overlap degree between the target object image and the guidance mask is greater than or equal to 0% and less than or equal to 100%. If the value of the overlap degree is 0%, the target object image and the guidance mask do not overlap; or if the value of the overlap degree is 100%, the target object image and the guidance mask completely overlap.

In some embodiments, a quantity of pixels in the target object image may be further calculated by using the edge feature point of the target object image, the pixels in the target object image and pixels in the guidance mask are overlapped, a quantity of overlapped pixels between the target object image and the guidance mask is calculated, and the overlap degree between the target object image and the guidance mask is obtained based on the quantity of overlapped pixels. For example, a ratio of the quantity of overlapped pixels to a total quantity of image pixels is calculated to obtain the overlap degree between the target object image and the guidance mask. The total quantity of image pixels is a union of a quantity of pixels of the target object image and a quantity of pixels of the guidance mask. The quantity of overlapped pixels may be understood as an intersection of the quantity of pixels of the target object image and the quantity of pixels of the guidance mask.

In some embodiments, when the overlap degree between the target object image and the guidance mask reaches the first threshold, the target object image has been correctly placed at a specified location (a location of the guidance mask) on the camera capture preview interface, e.g., the target object image and the guidance mask have been aligned. In this case, the interface switches from the camera capture preview interface to the virtual trial interface, and an effect that the virtual product effect of the target recommended product is superimposed and displayed on the target part in an AR form is displayed on the virtual trial interface.

In Some embodiments of the present disclosure, whether the target object image is at a correct location is determined on the camera capture preview interface by determining the overlap degree between the target object image and the guidance mask. Once the overlap degree satisfies a condition, e.g., the overlap degree reaches the first threshold, the virtual product effect of the target recommended product is superimposed and displayed on the target part. Such an instant feedback mechanism enables the user to perceive immediacy and effectiveness of an operation. In addition, precise positioning reduces a need for the user to adjust a location, and improves smoothness and naturalness of try-on experience.

The target object image is analyzed based on AI, to obtain a recommendation list.

In some embodiments, the target object image is analyzed based on an AI algorithm based on the overlap degree between the target object image and the guidance mask satisfying the first threshold, to obtain the recommendation list. In some embodiments, the target recommended product is obtained from the recommendation list.

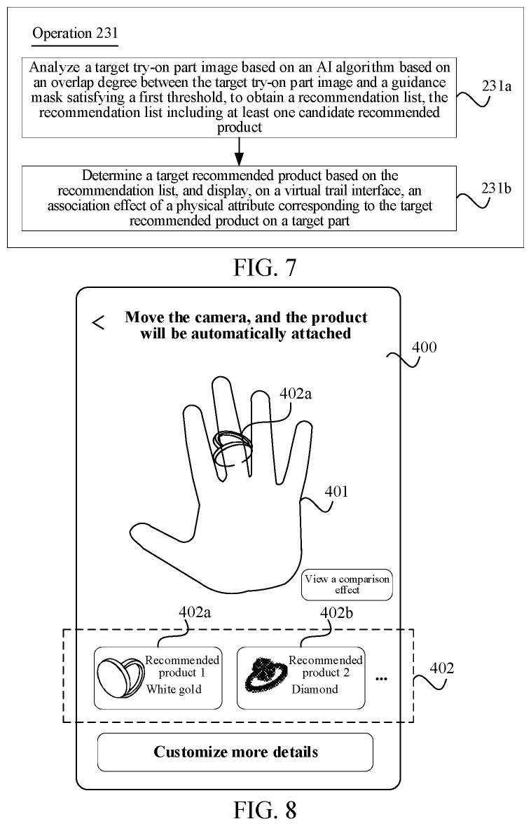

FIG. 7 is a flowchart of a recommendation-based interaction method according to some embodiments of the present disclosure. Operation 231 may be replaced with operations 231a and 231b.

In the some embodiments, operations may be performed sequentially, in a different order, in parallel, or with some operations skipped or repeated.

Operation 231a: Analyze the target object image based on the AI algorithm based on the overlap degree between the target object image and the guidance mask satisfying the first threshold, to obtain the recommendation list, the recommendation list including at least one candidate recommended product.

The recommendation list includes a group of candidate recommended products obtained by analyzing the target object image based on the AI algorithm. The AI algorithm may be a neural network model. An input of the neural network model is the target object image, and an output is the group of candidate recommended products. The neural network model includes but is not limited to a convolutional neural network, a deep network model, a large language model, and the like.

In some embodiments, the recommendation list has different layouts. The layout of the recommendation list is usually an optimized arrangement of the recommendation list that renders the recommendation list clearer, easier to read, and more aesthetically pleasing. The recommendation list is a set of a plurality of candidate recommended products. In some embodiments, the layout of the recommendation list includes at least one of a grid layout, a list layout, a card layout, a slide tab, a waterfall flow layout, or a carousel layout.

For example, the layout of the recommendation list is the grid layout, the plurality of candidate recommended products are arranged in a grid form, an icon or a name of each candidate recommended product occupies one fixed-size grid cell, and the user may view more candidate recommended products through scrolling or paging. The layout of the recommendation list is the list layout, the plurality of candidate recommended products are presented in a form of a vertical list, the candidate recommended products are arranged in sequence, and the user may browse all the candidate recommended products through scrolling. The layout of the recommendation list is the card layout, each candidate recommended product is displayed in a form of a card, including an icon, a name, and a brief description, and the user may select the corresponding candidate recommended product by tapping or touching the card. The layout of the recommendation list is a slide tab, the slide tab is placed at the top or bottom of the virtual trial interface, each slide tab represents a different type or category of candidate recommended products, and the user may switch different categories of candidate recommended products by sliding or tapping the slide tab. The layout of the recommendation list is the waterfall flow layout, the waterfall flow layout is a dynamic grid layout, and a size of a thumbnail of each candidate recommended product may be different, so that the recommendation list looks more dynamic and natural as a whole. The layout of the recommendation list is the carousel layout, the candidate recommended products are presented in loop in a form of a carousel image, and the user may slide left and right to browse different candidate recommended products.

In some embodiments, the recommendation list is a group of candidate recommended products obtained by the server by analyzing the target object image based on the neural network model. First, the camera of the terminal device obtains the target object image of the user, and transmits the target object image to the server. The server processes the target object image, and extracts a key image feature from the target object image. Then, the server queries a product library of the first recommended product, the product library including products owned by a brand to which the first recommended product belongs. The server finds, from the product library, a product belonging to the same type as the first recommended product. Next, the server performs fitting between the extracted key image feature and the products in the product library based on a matching algorithm, and selects the group of candidate recommended products from the product library based on a fitting result, fitness between the selected candidate recommended products and the target object image reaching a preset fitting standard. Finally, the server transmits the selected candidate recommended products to the terminal device. The terminal device receives the candidate recommended products, and generates the recommendation list. The candidate recommended products in the recommendation list are recommended products matching (or referred to as fitting) the target object image.

In some embodiments, the server analyzes the target object image based on the neural network model, to obtain the candidate recommended product for the target object image. In some embodiments, a recommendation model (a neural network model) is pre-trained, and the recommendation model may generate the corresponding recommendation list based on the target object image. In some embodiments, an image data set (e.g., a data set corresponding to the target object image) is obtained, and the image data set is used as a training sample to train the recommendation model. The training sample is a sample obtained in a user feedback driven manner. The recommendation model may be trained based on the training sample, to obtain a recommendation model with a recommendation capability. The training sample is obtained in the following manner: first obtaining the target object image captured by the camera; randomly displaying the recommendation list when the target object image satisfies the capture condition; and obtaining a binding relationship between a preset recommended product and the target object image based on a positive feedback operation on the preset recommended product in the recommendation list, the positive feedback operation including at least one of a selection operation, a try-on operation, and a sharing operation on the preset recommended product, and using the target object image and the preset recommended product as training samples to train the recommendation model.

In some embodiments, the training sample is obtained in the user feedback driven manner, the recommendation model is trained by using the training sample, and a label of the training sample may be obtained based on the binding relationship between the preset recommended product and the target object image, e.g., the preset recommended product selected by the user is used as label data of the training sample. In some embodiments, an input of the recommendation model is a feature vector. An image is converted into an image feature through a preset operation. A detail local feature is extracted from an image of each training sample as the image feature by using image detection and image feature extraction technologies. Then, the image feature and a label corresponding to the image are inputted into the recommendation model as input data, and the recommendation model is trained based on different image features and the labels (preset recommended products) of the images. The recommendation model can learn a mapping relationship between an image and a preset recommended product. The recommendation model predicts the input data, to obtain a training result of the image feature. The training result (a recommended product) is compared with a true result (the preset recommended product corresponding to the training sample), to obtain a calculation loss. The calculation loss is configured for indicating an error between the training result and the true result. In some embodiments, a back propagation algorithm is used to adjust a parameter of the recommendation model, so that an output of the recommendation model is closer to the label corresponding to the training sample. In some embodiments, the recommendation model is optimized by using a loss function. Based on this, the trained recommendation model is obtained. The trained recommendation model can learn the mapping relationship between the image and the preset recommended product.

Training of the recommendation model provided in this embodiment is merely an example description, and does not constitute a limitation on a training manner of the recommendation model.

Operation 231b: Determine the target recommended product based on the recommendation list, and display, on the virtual trial interface, the associated effect of the physical attribute corresponding to the target recommended product on the target part.

In some embodiments, for each candidate recommended product in the recommendation list, the server determines the fitness between the candidate recommended product and the target object image, to obtain a fitness calculation result between each candidate recommended product and the target object image, and then determines the target recommended product from the recommendation list based on the fitness calculation result. In some embodiments, the fitness calculation result may be represented as a fitness score, and a candidate recommended product with a highest fitness score may be ranked first in the recommendation list.

In some embodiments, different fitness between the target object image and the candidate recommended product corresponds to different reference standards. For example, when the target object image is a hand image, a reference standard corresponding to the hand image includes but is not limited to at least one of a shape, a size, and a color of the hand. For example, when the target object image is a neck image, a reference standard corresponding to the neck image includes but is not limited to at least one of a color and smoothness of the neck. For example, when the target object image is a lip image, a reference standard corresponding to the lip image includes but is not limited to at least one of a color and a shape of the lip.

In some embodiments, the terminal device displays the at least one candidate recommended product in the recommendation list in descending order of the fitness with the target object image. In some embodiments, the terminal device determines an n^{th} candidate recommended product in the descending order as the target recommended products, n being a positive integer. For example, a first-ranked candidate recommended product is determined as the target recommended product. In some embodiments, the associated effect of the physical attribute corresponding to the target recommended product on the target part is displayed. The associated effect is the virtual product effect of the target recommended product. For example, the virtual product effect of the target recommended product is displayed on the target part (including the body part and the target spatial location) in an AR form.

In some embodiments, the target object image is analyzed based on the AI algorithm, to obtain the recommendation list. Based on fitness between the at least one candidate recommended product in the recommendation list and the target object image, a candidate recommended product whose fitness with the target object image reaches a second threshold is determined from the recommendation list as the target recommended product. For example, the candidate recommended product in the recommendation list whose fitness with the target object image reaches the second threshold is determined as the target recommended product. The virtual product effect of the target recommended product is displayed on the target part (including the body part and the target spatial location) in an AR form by default.

For example, when the overlap degree between the target object image and the guidance mask satisfies the capture condition (reaches the first threshold), the target object image is aligned with the guidance mask are aligned. In this case, the interface switches from the camera capture preview interface to the virtual trial interface. As shown in FIG. 8, a virtual product effect of a target recommended product 402a is displayed on the target part in an AR form on a virtual trial interface 400. In some embodiments, after the capture condition is satisfied, a target object image 401 is analyzed based on AI. For example, the target object image 401 is a hand image. In this way, a recommendation list 402 for the target object image 401 is obtained. The recommendation list 402 includes at least one candidate recommended product. For example, the recommendation list 402 includes the candidate recommended product 402a, a candidate recommended product 402b, . . . , and the candidate recommended products in the recommendation list 402 are ranked in descending order of fitness with the target object image 401. The candidate recommended product 402a ranked first is determined as the target recommended product, and the virtual product effect of the target recommended product is displayed on the hand of the user in an AR form by default.

In this embodiment of the present disclosure, the candidate recommended products are automatically sorted based on the fitness with the target object image. Recommendation based on a personal feature of the user implements personalized recommendation, ensures that the presented recommended product meets a requirement of the user, and enables the user to quickly and intuitively preview a product style or design most suitable for the user, improving recommendation accuracy.

In some embodiments, based on a selection operation on a candidate recommended product in the recommendation list, the candidate recommended product selected through the selection operation is determined as the target recommended product, and the associated effect of the physical attribute corresponding to the selected candidate recommended product (e.g., the target recommended product) on the target part is displayed on the virtual trial interface. In some embodiments, the recommendation list includes the at least one candidate recommended product, and the at least one candidate recommended product is sorted in descending order of the fitness with the target object image. The n^{th} candidate recommended product is determined as the target recommended product by default, and is displayed on the target part in an AR form. For example, the first-ranked candidate recommended product is determined as the target recommended product by default. The target recommended product displayed by default may not be a product in which the user is interested. In this case, the user may further select another candidate recommended product in the recommendation list based on a personal preference.

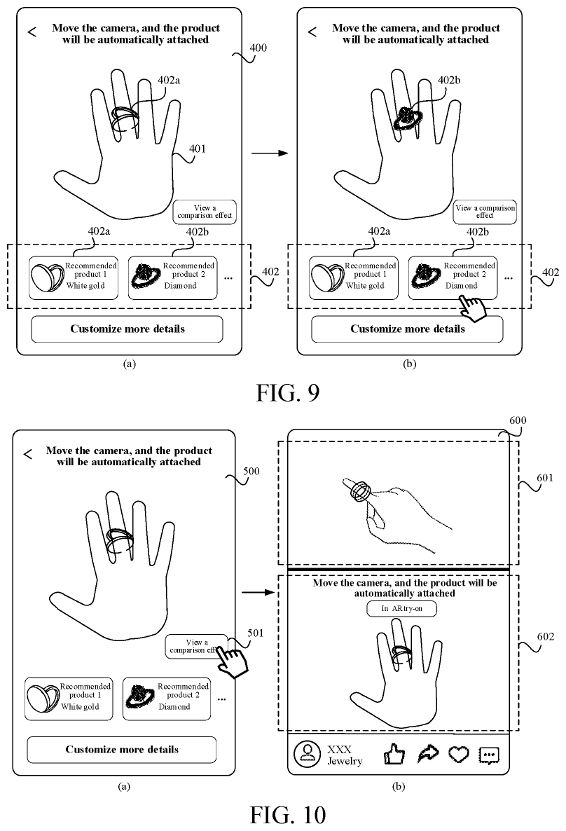

For example, refer to FIG. 9. As shown in (a) in FIG. 9, the recommendation list 402 corresponding to the target object image 401 is displayed on the virtual trial interface 400. The recommendation list 402 includes at least one candidate recommended product. For example, the recommendation list 402 includes the candidate recommended product 402a, the candidate recommended product 402b, . . . , and the candidate recommended products in the recommendation list 402 are sorted in descending order of the fitness with the target object image 401. The candidate recommended product 402a ranked first is determined as the target recommended product by default. In some embodiments, the user may further select another candidate recommended product in the recommendation list 402 based on the personal preference. As shown in FIG. (b) in FIG. 9, based on a selection operation of the user on the candidate recommended product 402b in the recommendation list 402, a virtual product effect of the selected candidate recommended product 402b is displayed on the hand of the user in an AR form.

In some embodiments of the present disclosure, the user may further select another candidate recommended product in the recommendation list based on the personal preference, and a virtual product effect of the selected candidate recommended product is displayed on the target part in an AR form. Such an instant feedback mechanism enables the user to quickly see a virtual try-on effect of the selected product, improving convenience of interaction.

In conclusion, according to the method provided in some embodiments of the present disclosure, the server can analyze the target object image by using the AI algorithm, to generate the recommendation list, and the candidate recommended product in the recommendation list better meets an actual requirement of the user. Such personalized recommendation can improve accuracy and a correlation between the candidate recommended product and the target object image. The target recommended product is determined by setting a fitness threshold, so that a product most matching the target object image can be selected from the recommendation list. Such a selection mechanism can reduce difficulty of selection from a plurality of products by the user, and improve selection efficiency.

In some embodiments, the associated effect is the virtual product effect of the target recommended product. After the virtual product effect of the target recommended product is displayed on the target part in an AR form, the user can interact with the target recommended product, and change the virtual product effect of the target recommended product through an interactive operation.

The associated effect of the physical attribute corresponding to the target recommended product on the target part is updated based on an interactive operation on the target recommended product. For example, associated effects between the physical attribute corresponding to the target recommended product and the target part in different presentation manners are displayed on the target part.

The interactive operation is an operation of interacting with the target recommended product on the virtual trial interface. In some embodiments, the interactive operation includes but is not limited to at least one of a rotation operation, a zoom-in operation, a zoom-out operation, and a movement operation. The presentation manner is a manner of presenting the virtual product effect of the target recommended product under different interactive operations.

The associated effect is the virtual product effect of the target recommended product.

In some embodiments, when the target recommended product is an accessory product or a makeup product for modifying the body part of the user, the target part is the body part of the user, and the physical attribute corresponding to the target recommended product is a modification effect of the accessory product or the makeup product.

In some embodiments, when the target recommended product is a decorative product or a practical product, the target part is the target spatial location, and the physical attribute corresponding to the target recommended product is an actual physical feature of the decorative product or the practical product.

In some embodiments of the present disclosure, the user is allowed to interactively preview virtual effects of the target recommended product in different presentation manners on the target part, to feel the effect of the target recommended product more intuitively, improving interestingness and satisfaction of the user.

The virtual product effect of the target recommended product is presented in a plurality of dimensions.

### For a First Interactive Operation (the Rotation Operation)

In some embodiments, an angle of the target recommended product is rotated based on the first interactive operation on the target recommended product, and an associated effect of the physical attribute corresponding to the rotated target recommended product on the target part is displayed on the target part. The first interactive operation is the rotation operation. In some embodiments, the rotation operation includes at least one of an upward rotation operation, a downward rotation operation, a leftward rotation operation, a rightward rotation operation, and a custom rotation operation. For example, the custom rotation operation is a rotation operation in which a slide trajectory is set to an arc.

In some embodiments, the angle of the target recommended product is rotated based on the rotation operation on the target recommended product. After the presentation angle of the target recommended product changes, the user can view the target recommended product from a different angle. After the user performs the rotation operation, the virtual product effect of the rotated target recommended product is updated and displayed on the target part. By rotating the angle of the target recommended product, the user can view the target recommended product from different viewing angles, to obtain more comprehensive visual experience.

### For a Second Interactive Operation (the Zoom-In Operation)

In some embodiments, the target recommended product is zoomed in, based on the second interactive operation on the target recommended product, and an associated effect of the physical attribute corresponding to the zoomed-in target recommended product on the target part is displayed on the target part. The second interactive operation is the zoom-in operation. In some embodiments, the zoom-in operation includes a partial zoom-in operation or an overall zoom-in operation.

In some embodiments, the target recommended product is zoomed in, based on the zoom-in operation on the target recommended product. After a size of the target recommended product changes, a virtual product effect achieved through zoom-in is presented on the target part, and the user can see more product details. For example, the user double-taps the target recommended product on the virtual trial interface, to zoom in the virtual product effect of the target recommended product, and the virtual product effect of the target recommended product is restored based on the user double-tapping the target recommended product again.

For example, the target recommended product is a practical product, for example, a sofa. After the capture condition is satisfied, the sofa is displayed in a preset size at a central regional location on the ground of the living room. In some embodiments, based on a zoom-in operation on the sofa, a virtual product effect of the zoomed-in sofa is displayed at the central regional location on the ground of the living room.

### For a Third Interactive Operation (the Zoom-Out Operation)

In some embodiments, the target recommended product is zoomed out based on the third interactive operation on the target recommended product, and an associated effect of the physical attribute corresponding to the zoomed-out target recommended product on the target part is displayed. The third interactive operation is the zoom-out operation.

In some embodiments, the target recommended product is zoomed out based on the zoom-out operation on the target recommended product. After a size of the target recommended product changes, a virtual product effect achieved through zoom-out is presented on the target part. For example, the user performs the zoom-out operation with two fingers, to reduce a display size of the virtual product effect of the target recommended product on the virtual trial interface.

### For a Fourth Interactive Operation (the Movement Operation)

In some embodiments, the target recommended product is moved based on the fourth interactive operation on the target recommended product, and an associated effect of the physical attribute corresponding to the moved target recommended product is displayed on target part. The fourth interactive operation is the movement operation. In some embodiments, the movement operation includes at least one of an upward movement operation, a downward movement operation, a leftward movement operation, a rightward movement operation, and a custom movement operation. For example, the custom movement operation is a movement operation in which a slide trajectory is set to an arc. A movement direction of the target recommended product is related to the move operation. For example, the virtual product effect of the target recommended product on the target part is moved upward based on the upward movement operation.

In some embodiments, the target recommended product is moved based on the movement operation on the target recommended product. A location of the virtual product effect of the target recommended product on the target part may change, and the user may view try-on effects of the virtual product effect of the target recommended product at different locations of the target part.

For example, the target recommended product is a ring, and the virtual product effect of the ring is worn on a middle finger by default. The user may move the ring from the middle finger to an index finger through a movement operation, to view a try-on effect of the virtual product effect of the ring worn on the index finger.

For example, the target recommended product is a sofa. The sofa is displayed at a central regional location on the ground of the living room by default. In some embodiments, a virtual product effect of the sofa after the sofa is moved from a central regional location A to another regional location B is displayed based on a movement operation on the sofa.

In some embodiments of the present disclosure, the user interacts with the target recommended product through a multidimensional interactive operation (rotate, zoom-in, zoom-out, and move), to more freely explore and experience virtual product effects of the target recommended product under different angles, sizes, and locations.

### Another Interactive Operation

### (1) Motion Change of the Target Part

In some embodiments, based on the motion change of the target part, an associated effect following the motion change of the target part between the physical attribute corresponding to the target recommended product and the target part is displayed.

In some embodiments, after the capture condition is satisfied, the current interface switches from the camera capture preview interface to the virtual trial interface, and the target recommended product is automatically attached to the target part. Automatic attachment means that the virtual product effect of the target recommended product can be automatically identified and attached to the target part.

In some embodiments, when the target recommended product is an accessory product or a makeup product for modifying the body part of the user, the target part is the body part of the user, and the physical attribute corresponding to the target recommended product is a modification effect of the accessory product or the makeup product. In some embodiments, when the target recommended product is a decorative product or a practical product, the target part is the target spatial location, and the physical attribute corresponding to the target recommended product is an actual physical feature of the decorative product or the practical product.

In some embodiments, based on the motion change of the target part of the user, an associated effect following the motion change of the target part between the physical attribute corresponding to the target recommended product and the target part is displayed. For example, the virtual product effect of the target recommended product synchronously changes with the motion change of the user. The virtual product effect changes in real time with a location and a posture of the target part in real time, and a location and an angle of the virtual product effect on the screen are correspondingly updated, to keep consistency with a motion of the user.

For example, the target recommended product is an accessory product, for example, a ring. After the capture condition is satisfied, the ring is automatically attached to a finger location of the user. In some embodiments, a virtual product effect of the ring is moves upward with the finger based on an upward movement operation of the finger. The virtual product effect of the ring is moved downward with the finger based on a downward movement operation of the finger. The virtual product effect of the ring is moved leftward with the finger based on a leftward movement operation of the finger. The virtual product effect of the ring is moved rightward with the finger based on a rightward movement operation of the finger. The virtual product effect of the ring is moved freely with the finger based on a free movement operation of the finger in a three-dimensional space. An effect of the virtual product effect of the ring being bent with the finger is displayed based on a bending operation of the finger.

For example, the target recommended product is an accessory product, for example, a bracelet. After the capture condition is satisfied, the bracelet is automatically attached to a wrist location of the user. In some embodiments, a virtual product effect of the bracelet is moved with the wrist based on a movement operation of the wrist. The virtual product effect of the bracelet is rotated with the wrist based on a rotation operation of the wrist. The virtual product effect of the bracelet is shaken with the wrist based on a shaking operation of the wrist.

For example, the target recommended product is a makeup product, for example, a lipstick. After the capture condition is satisfied, the lipstick is automatically attached to a lip location of the user. In some embodiments, a virtual product effect of the lipstick is moved with the lip based on a movement operation of the lip. The virtual product effect of the lipstick follows a motion change of the lip based on a talking motion of the user. The virtual product effect of the lipstick changes with a change amplitude of the lip based on a facial expression of the user changing.

In some embodiments of the present disclosure, the target recommended product is automatically attached to the target part, and can respond to the motion change of the user, ensuring that the virtual product effect synchronously changes with the target part. This design provides smooth and interactive try-on experience, so that the user can view a more realistic virtual product effect.

### (2) Switching of an AR Display Scenario

In some embodiments, the associated effect of the physical attribute corresponding to the target recommended product on the target part is displayed in a switched virtual background based on a switching operation on a virtual background of the virtual trial interface.

In a possible implementation, a background switching control is displayed on the virtual trial interface. The switching operation is performed on the virtual background based on a touch operation on the background switching control, and a try-on effect of the virtual product effect of the target recommended product on the target part in an AR form is displayed in the switched virtual background. The virtual background is configured for simulating a real life scenario. Different virtual backgrounds are configured for simulating different real life scenarios. The virtual background is displayed on the virtual trial interface as a display background of the associated effect of the physical attribute corresponding to the target recommended product on the target part. The background switching control is an interface element on the virtual trial interface that is configured for triggering virtual background switching. In some embodiments, the background switching control is usually presented in a form of an icon, a button, text, or the like.

In some embodiments, a virtual background selection list is popped up on the virtual trial interface based on the touch operation on the background switching control, the user may select any virtual background in the virtual background selection list, and a try-on effect of the virtual product effect of the target recommended product on the target part in an AR form is displayed in the selected virtual background.

For example, the virtual background in the virtual background selection list includes but is not limited to at least one of a motion virtual background, a working virtual background, an entertainment virtual background, a home virtual background, a leisure virtual background, and a travel virtual background. The user switches, through selection operations on different virtual backgrounds, the virtual background in which the virtual product effect of the target recommended product is displayed, to simulate display effects of the target recommended product in different real life scenarios.

In a possible implementation, a random switching operation is performed on the virtual background based on a tap operation on the virtual background, and a try-on effect of the virtual product effect of the target recommended product being superimposed and displayed on the target part in an AR form is displayed in a scenario after random switching. The virtual background is configured for simulating different real life scenarios.

In some embodiments, a randomly switchable virtual background includes but is not limited to at least one of a motion virtual background, a working virtual background, an entertainment virtual background, a home virtual background, a leisure virtual background, and a travel virtual background. For example, the virtual background is switched from the home virtual background to the working virtual background based on a tap operation on the virtual background, and the try-on effect of the virtual product effect of the target recommended product being superimposed and displayed on the target part in an AR form is displayed in the working virtual background after random switching.

In some embodiments of the present disclosure, the user may switch the virtual background to simulate try-on effects of the product effect of the target recommended product being superimposed and displayed on the target part in an AR form in different scenarios. Such a virtual background switching manner provides the user with evaluation of fitness of the target recommended product in different life scenarios, and allows the user to preview the virtual product effect in different life scenarios such as daily leisure, sports, or formal occasions, to adapt to different user requirements, providing a more personalized service.

### (3) Split-Screen Display for Effect Comparison

In some embodiments, a split-screen control is displayed, and the virtual trial interface and a presentation interface are controlled to be displayed in a split-screen form based on a trigger operation on the split-screen control.

The virtual trial interface is an interface displaying the associated effect of the physical attribute corresponding to the target recommended product on the target part. For example, the virtual trial interface is an interface on which the virtual product effect of the target recommended product is displayed on the target part in an AR form. The presentation interface is an interface configured for presenting the first recommended product. For example, the presentation interface is the short video playback interface. The split-screen control may be displayed on the virtual trial interface. The screen-split control is an interface element configured for triggering split-screen display of the virtual background interface. In some embodiments, the split-screen control is usually presented in a form of an icon, a button, text, or the like.

In some embodiments, the screen of the terminal device is divided into two regions based on the trigger operation on the split-screen control, where one part of region of the screen is configured for displaying the virtual trial interface, and the other part of region of the screen is configured for displaying the presentation interface. In this case, an interface displayed on the screen is also referred to as a comparison interface. For example, an upper region on the comparison interface is configured for displaying the virtual trial interface, and a lower region on the comparison interface is configured for displaying the presentation interface.

In some embodiments, based on the trigger operation on the split-screen control, the virtual trial interface and the short video playback interface are controlled to be displayed on the comparison interface based on a split-screen ratio. The split-screen ratio is configured for indicating a ratio of an area of the virtual trial interface to an area of the presentation interface on the comparison interface. For example, the virtual trial interface and the presentation interface are controlled to perform split-screen display based on the trigger operation on the split-screen control. For example, the split-screen ratio is 1:1, e.g., the virtual trial interface and the presentation interface each occupy half (e.g., 50%) of the comparison interface. For another example, the split-screen ratio is 3:2, e.g., the virtual trial interface and the presentation interface respectively occupy 60% and 40% of the comparison interface. A specific value of the split-screen ratio is not limited in the present disclosure.

For example, refer to FIG. 10. As shown in (a) in FIG. 10, a virtual trial interface 500 is displayed. A split-screen control 501 is displayed on the virtual trial interface 500. For example, the split-screen control 501 is “View a comparison effect”. Based on a trigger operation on the split-screen control 501, as shown in (b) in FIG. 10, split-screen interface display is controlled, the presentation interface, for example, the short video playback interface, is displayed in an upper region 601 on a comparison interface 600, and the virtual trial interface is displayed in a lower region 602 on the comparison interface 600. In some embodiments, a proportion of the short video playback interface and a proportion of the virtual trial interface on the comparison interface 600 during split-screen display are different. For example, the proportion of the short video playback interface is 40%, and the proportion of the virtual trial interface is 60%.

In some embodiments of the present disclosure, split-screen display of the virtual trial interface and the short video playback interface enables the user to view a demonstration of the recommended product while performing virtual try-on, to better evaluate an actual effect of the recommended product, and helps the user obtain more information while trying on the virtual product, for assisting in making a purchase decision.

(4) Interaction with a Friend

In some embodiments, a share control is displayed, the share control being configured for triggering a first account to share the virtual trial interface with a second account. An interaction frame of the first account and the second account is displayed on the virtual trial interface based on a joining operation of the second account.

The share control is an interface element configured for triggering the first account to share the virtual trial interface with the second account. In some embodiments, the share control is usually presented in a form of an icon, a button, text, or the like. In some embodiments, the first account may be an account currently used by the user, and the second account is an account having a friendship with the first account.

In some embodiments, the second account may receive a sharing request of the first account based on the sharing operation on the virtual trial interface. The second account joining the virtual trial interface is displayed based on the second account receiving the sharing request of the first account.

In some embodiments, an interaction frame in which the user of the first account and a user of the second account may interact on the virtual trial interface is displayed based on the joining operation of the second account. For example, the user of the first account and the user of the second account may simulate a handshake on the virtual trial interface.

In some embodiments of the present disclosure, an interaction option or an automatic interaction scenario is provided, so that the user can interact with another person in a virtual try-on process, and share and compare try-on effects, enhancing user experience.

(5) Comparison with Another Brand

In some embodiments, the target recommended product is a recommended product of a first brand, a recommended product of a second brand is displayed in a preset region on the virtual trial interface, and navigating to a details interface of the recommended product of the second brand is displayed based on a selection operation on the recommended product of the second brand.

The virtual trial interface is an interface displaying the associated effect of the physical attribute corresponding to the target recommended product on the target part.

In some embodiments, the associated effect of the physical attribute corresponding to the target recommended product displayed on the target part on the virtual trial interface. For example, an effect of the virtual product effect of the target recommended product being displayed on the target part in an AR form is displayed on the virtual trial interface. The target recommended product belongs to the first brand, and the recommended product of the second brand may be displayed in the preset region on the virtual trial interface. The first brand and the second brand are different product brands. In some embodiments, the interface navigates to the details interface of the recommended product of the second brand through the selection operation on the recommended product of the second brand. The details interface includes but is not limited to at least one of details, a price, and an interactive control of the recommended product of the second brand. In some embodiments, details and a price of the target recommended product of the first brand are displayed on the virtual trial interface, and the user may compare the target recommended product of the first brand with the recommended product of the second brand.

In some embodiments of the present disclosure, a comparison between brands is provided, and the user can see recommended products of different brands on the virtual trial interface. By comparing the recommended products of different brands, the user can conveniently make a more comprehensive purchase decision.

### Interactive Operation on the Short Video Playback Interface

In some embodiments, the recommendation short video of the first recommended product is displayed on the short video playback interface. The recommendation short video includes content of try-on of the first recommended product by a model figure. The user may determine, by evaluating a try-on effect of the model figure, whether to interact for virtual try-on.
Content of a virtual product effect of the first recommended product after color switching acting on the model figure is displayed in the recommendation short video based on a first switching operation on a color of the first recommended product, and promotion content corresponding to the first recommended product after switching is displayed.

The first switching operation is configured for switching a color of the first recommended product. The first switching operation may be a selection operation on a first recommended product of a different color.

In some embodiments, the recommendation short video includes the content of try-on of the first recommended product by the model figure, and first recommended products of different colors are displayed in the recommendation short video. In some embodiments, the first recommended products of different colors correspond to different promotion content. The promotion content includes a promotion slogan corresponding to the first recommended product and video content of the recommendation short video.

For example, the first recommended product is a makeup product, for example, a lipstick. The lipstick includes shades corresponding to different colors. The user may switch, in the recommendation short video through a switching operation on a lipstick of a different color, to displaying a makeup product effect of the lipstick of the different color acting on the model figure, and displaying different promotion content corresponding to the lipstick of the different color.
Content of a product effect of the first recommended product after model switching acting on the model figure is displayed in the recommendation short video based on a second switching operation on a model of the first recommended product, and promotion content corresponding to the first recommended product after model switching is displayed.

The second switching operation is configured for switching a model of the first recommended product. The second switching operation may be a selection operation on a first recommended product of a different model.

In some embodiments, the recommendation short video includes the content of trial of the first recommended product by the model figure, and first recommended products of different models are displayed in the recommendation short video. In some embodiments, the first recommended products of different models correspond to different promotion content. The promotion content includes a promotion slogan corresponding to the first recommended product and video content of the recommendation short video.

For example, the first recommended product is an accessory product, for example, a ring. The ring includes styles corresponding to different models. The user may switch, in the recommendation short video through a switching operation on a ring of a different model, to displaying a trial product effect of the ring of the different model acting on the model figure, and displaying different promotion content corresponding to the ring of different model.

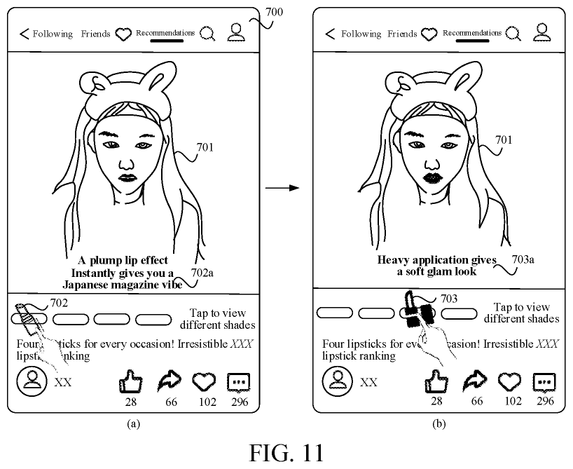

For example, refer to FIG. 11. As shown in (a) in FIG. 11, the recommendation short video of the first recommended product is displayed on a short video interface 700. The recommendation short video includes content of trial of the first recommended product by a model FIG. 701. In some embodiments, the first recommended product is a makeup product, for example, a lipstick. The recommendation short video includes content of trial of the lipstick by the model FIG. 701. Lipsticks of different colors are displayed in the recommendation short video. A makeup product effect of a lipstick 702 of a first color acting on the model FIG. 701 is displayed based on a tap operation on the lipstick 702 of the first color, and a promotion slogan 702a, for example, “A plump lip effect instantly gives you a Japanese magazine vibe”, corresponding to the lipstick 702 of the first color. A makeup product effect of a lipstick corresponding to a switched color acting on the model FIG. 701 is displayed in the recommendation short video based on a switching operation on the lipsticks of different colors. As shown in (b) in FIG. 11, a makeup product effect of a lipstick 703 of a second color acting on the model FIG. 701 is displayed based on a tap operation on the lipstick 703 of the first color, and a promotion slogan 703a, for example, “Heavy application gives a soft glam look”, corresponding to the lipstick 703 of the second color.

In some embodiments of the present disclosure, switching is performed to display, in the recommendation short video based on a switching operation on a different color or a different model of the first recommended product, content of a virtual product effect of the first recommended product of the different color or the different model acting on the model figure. The user may more intuitively see makeup effects of different colors and models. The user may determine, based on the try-on effect of the model figure, whether to perform virtual try-on, and obtain more product details and promotion content by using the recommendation short video, enhancing interaction enthusiasm and purchase will of the user.

Conversion processing is performed based on the virtual trial interface.

In some embodiments, after a conversion condition is satisfied, conversion processing is performed based on the virtual trial interface, the conversion processing including at least one of navigating to a purchase interface of the target recommended product, navigating to an introduction interface of the target recommended product, and navigating to an interactive interface of the target recommended product.

In some embodiments, the conversion condition is a condition for triggering switching from the virtual trial interface to a third-party interface. The third-party interface includes the purchase interface of the target recommended product, the introduction interface of the target recommended product, and the interactive interface of the target recommended product. In some embodiments, the conversion condition is a time condition. For example, the conversion condition is that duration for which the virtual product effect of the target recommended product is displayed on the target part in an AR form reaches preset duration.

In some embodiments, the purchase interface of the target recommended product may be configured at least for purchasing the target recommended product. The introduction interface of the target recommended product includes but is not limited to an advertisement promotion page. The current user may share the advertisement promotion page with another user. The interactive interface of the target recommended product may be configured for interaction with the another user. In some embodiments, interaction on the interactive interface includes but is not limited to presenting at least one of popularity information, voting information, comment information, and topic discussion information of the target recommended product. In some embodiments, the purchase interface, the introduction interface, the interactive interface, and the virtual trial interface of the target recommended product may be provided by a same application (or a mini program or a web page) installed on/accessed by the terminal, or may be provided by different applications (or mini programs or web pages) installed on/accessed by the terminal. This is not limited in the present disclosure.

In some embodiments of the present disclosure, after the duration for which the virtual product effect of the target recommended product is displayed on the target part in an AR form reaches the preset duration, the user may be directly navigated from the virtual trial interface to the purchase interface, the introduction interface, or the interactive interface of the target recommended product, reducing operations of searching for product information and completing purchase, and providing more smooth and efficient shopping experience. Performing conversion processing based on the virtual trial interface can improve a conversion rate of an advertised product.

In a possible implementation, a conversion entry (or referred to as a landing page access entry) is displayed around the target recommended product. Based on a trigger operation on the conversion entry, the interface navigates to a recommendation landing page corresponding to the target recommended product. The recommendation landing page includes detailed content about the target recommended product.

The conversion entry (the landing page access entry) is an access entry to the target recommended product. In some embodiments, the conversion entry is added around the target recommended product. The conversion entry may be a visual control, including at least one of a button, a link, or another navigation element. A representation form of the landing page access entry is not limited in the present disclosure.

In some embodiments, the recommendation landing page corresponding to the target recommended product is displayed through navigation based on the trigger operation of the user on the conversion entry. The recommendation landing page is a details page configured for presenting the target recommended product, and displays the detailed content related to the target recommended product, including, but not limited to, a video, a picture, an animation, an application, or another display element related to the target recommended product. In some embodiments, the recommendation landing page may be a page of another third-party application (for example, a page of a shopping application, or a web page of a merchant to which the product belongs). Specific content of the recommendation landing page is not limited in the present disclosure.

In some embodiments, by triggering the conversion entry, the user may be directly navigated from the virtual trial interface to the purchase interface of the target recommended product, and purchase the target recommended product on the purchase interface, without exiting the virtual test interface and tapping again, reducing a length of a purchase link and helping improve the conversion rate.

The trigger operation on the conversion entry includes but is not limited to an input operation, a voice operation, a tap operation, a touch-and-hold operation, a slide operation, a touch operation, a key operation, a gesture operation, or any combination of at least two of the foregoing operations.

In some embodiments of the present disclosure, the recommendation landing page is displayed by using the conversion entry triggered by the user. For example, the recommendation landing page is displayed to the user only when the user shows interest in the target recommended product. The recommendation landing page usually requires the user leaves the original interface, and if the recommendation landing page is automatically displayed, it is likely to interrupt an original browsing process of the user. Therefore, an interactive operation performed by the user on the conversion entry is identified to preliminarily determine an intention of the user, improving user experience. In addition, a client loads and displays the detailed content on the recommendation landing page only when the user actually triggers the conversion entry. This can reduce unnecessary resource occupation and improve a program response speed.

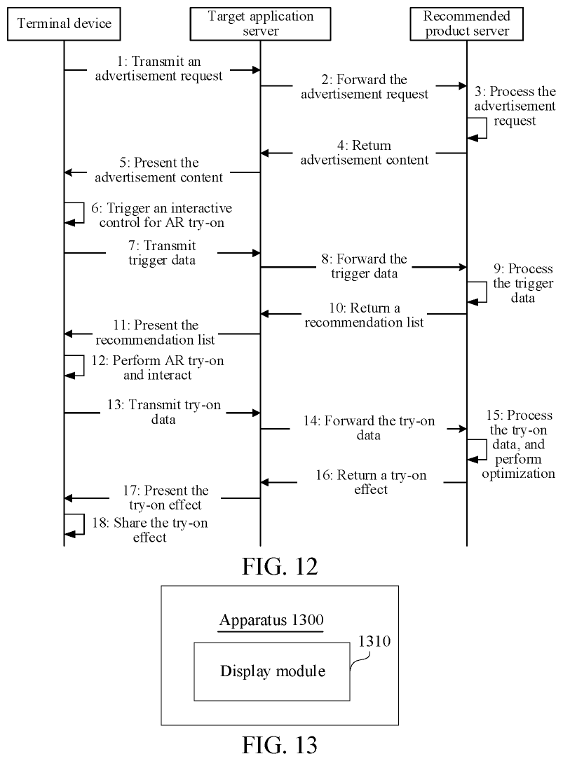

FIG. 12 is a sequence diagram of a recommendation-based interaction method according to some embodiments of the present disclosure. An example in which the method is jointly performed by the terminal device and the server shown in FIG. 1 is used for description. The server includes a target application server (a social platform on which recommendation short video is located) and a recommended product server.

In the some embodiments, operations may be performed sequentially, in a different order, in parallel, or with some operations skipped or repeated.

As shown in FIG. 12, the sequence diagram includes the following operations.

Operation 1: Transmit an advertisement request.

In some embodiments, the terminal device transmits the advertisement request to the target application server. A target application belongs to the social platform on which the recommendation short video is located. The recommendation short video is an information feed advertisement for recommending a first recommended product. The target application server transmits the advertisement request for the information feed advertisement to the terminal device.

Operation 2: Forward the advertisement request.

In some embodiments, the target application server forwards the advertisement request to the recommended product server.

Operation 3: Process the advertisement request.

In some embodiments, the recommended product server processes the advertisement request.

Operation 4: Return advertisement content.

In some embodiments, the recommended product server returns the advertisement content of the information feed advertisement to the target application server based on the advertisement request with recommendation information.

Operation 5: Present the advertisement content.

In some embodiments, the terminal device presents the advertisement content of the information feed advertisement on a short video playback interface.

Operation 6: Trigger an interactive control for AR try-on.

In some embodiments, the virtual interactive control is displayed on the short video playback interface, and AR try-on may be performed based on a trigger operation of a user on the virtual interactive control.

Operation 7: transmit trigger data.

The terminal device transmits the trigger data to the target application server based on a trigger operation of the user.

Operation 8: Forward the trigger data.

In some embodiments, the target application server forwards the trigger data to the recommended product server.

Operation 9: Process the trigger data.

Operation 10: Return a recommendation list.

In some embodiments, the recommended product server obtains the recommendation list after performing analysis based on the trigger data by using an AI algorithm. The recommendation list includes a group of candidate recommended products. The recommended product server returns the recommendation list to the target application server.

Operation 11: Present the recommendation list.

In some embodiments, the target application server returns the recommendation list to the terminal device, and the terminal device displays the recommendation list on a virtual trial interface. A first-ranked recommended product in the recommendation list is used as a target recommended product by default, and a virtual product effect of the target recommended product is superimposed and displayed on a target part in an AR form.

Operation 12: Perform AR try-on, and interact.

In some embodiments, the recommendation list includes at least one candidate recommended product. The user may further select another candidate recommended product in the recommendation list based on a personal preference, and the selected candidate recommended product is superimposed and displayed on the target part in an AR form.

In some embodiments, the user may interact with the target recommended product, for example, perform a rotation operation, a zoom-in operation, a zoom-out operation, or a movement operation. In some embodiments, the user may further perform another interactive operation, for example, move the target part or switch a virtual background.

Operation 13: Transmit try-on data.

In some embodiments, the terminal device transmits the try-on data to the target application server based on a selection operation of the user.

Operation 14: Forward the try-on data.

In some embodiments, the target application server forwards the try-on data to the recommended product server.

Operation 15: Process the try-on data, and perform optimization.

In some embodiments, the recommended product server processes the try-on data, and may further optimize a try-on effect of the first recommended product based on a reference standard of a target object image of the user.

Operation 16: Return to the try-on effect.

Operation 17: Display the try-on effect.

Operation 18: Share the try-on effect.

In some embodiments, a share control is displayed on the virtual trial interface, and the user may share the virtual trial interface with another user based on the share control.

In an application scenario, the recommendation-based interaction method may be applied to the field of accessory try-on. In some embodiments, the target recommended product is an accessory product, the target object image is a body part image, and may also be referred to as a target try-on part image, and the target part is a body part. An example in which the recommendation medium is the recommendation short video is used for description.

Operation 1: Display a recommendation short video of a first accessory and a virtual interactive control on a short video playback interface.

For example, a social interaction platform is installed and run on the terminal device. For example, an example in which a recommendation medium of the first accessory is the recommendation short video is used for description. The social interaction platform is designed with the short video playback interface. The short video playback interface includes social content that is published by at least one content publishing account and that is arranged by time. In some embodiments, the content publishing account is an advertisement account. The social content published by the content publishing account is advertisement content.

In some embodiments, the recommendation short video of the first accessory and the virtual interactive control are displayed on the short video playback interface. For example, the first accessory may be a ring, a bracelet, or a necklace.

Operation 2: Display a camera capture preview interface based on a trigger operation on the virtual interactive control.

In some embodiments, the trigger operation on the virtual interactive control includes a direct trigger operation and an indirect trigger operation. The indirect trigger operation on the virtual interactive control may be implemented by using a reaction component. In some embodiments, based on a positive reaction operation on the reaction component, it is determined that a condition of the indirect trigger operation on the virtual interactive control is satisfied.

In some embodiments, the camera capture preview interface is displayed based on the trigger operation on the virtual interactive control, the camera capture preview interface including prompt information configured for guiding capture of a target try-on part image. The target try-on part image is a body part image of the user. The prompt information is instructive information or a visual auxiliary element presented to the user on the camera capture preview interface. The prompt information is configured for showing the user how to capture the target try-on part image on the camera capture preview interface based on the camera.

In some embodiments, the prompt information is a guidance mask. The guidance mask may be a layer of preset transparency that covers the camera capture preview interface. The guidance mask is configured for guiding the user to acquire the target try-on part image. A shape of the guidance mask is related to a shape of a target try-on part.

For example, the first accessory is a ring, the pre-captured target try-on part image is a hand image, and the guidance mask is displayed as a palm-shaped layer. For another example, the first accessory is a necklace, the pre-captured target try-on part image is a neck image, and the guidance mask is displayed as a neck-shaped layer.

In some embodiments, the camera capture preview interface includes a capture box, and the guidance mask is displayed in the capture box. The capture box is located in a target region on the camera capture preview interface. A display form of the capture box is a rectangular frame form, a circular frame form, or a frame form of another shape. The target region is a display region of the capture box. The target region may be a preset region or a dynamically changing region. In some embodiments, a display size of the capture box changes with a distance between the target try-on part and the camera.

In some embodiments, the camera capture preview interface further includes capture prompt information. The capture prompt information is prompt information configured for guiding the target try-on part image to a location of the guidance mask. In some embodiments, a type of the capture prompt information includes but is not limited to at least one of text prompt information, arrow prompt information, and voice prompt information.

Operation 3: Display, based on the target try-on part image satisfying a capture condition, an associated effect of a physical attribute corresponding to a target accessory on a body part.

The capture condition is a standard condition that needs to be satisfied by the camera of the terminal device when capturing the target try-on part image. The target accessory is the first accessory or a second accessory belonging to a same type as the first accessory. The associated effect is a visual effect or an application effect generated when the physical attribute of the target accessory is combined with the body part. The physical attribute is an accessory decoration effect of the target accessory. In some embodiments, the associated effect acting on the body part is a virtual product effect.

The associated effect of the physical attribute corresponding to the target accessory on the body part is displayed based on the target try-on part image satisfying the capture condition or based on an overlap degree between the target try-on part image and the guidance mask satisfying a first threshold. The associated effect is the virtual product effect of the target accessory. The target accessory is superimposed and displayed on the body part in an AR form on a virtual trial interface.

The overlap degree is an overlapping degree between the target try-on part image and the guidance mask. The overlap degree is configured for measuring consistency between the body part and the guidance mask. If the overlap degree reaches or exceeds the preset first threshold, an effect of the target accessory being superimposed and displayed on the body part in an AR form is displayed.

In some embodiments, the target try-on part image is analyzed based on an AI algorithm based on the overlap degree between the target try-on part image and the guidance mask satisfying the first threshold, to obtain a recommendation list. The recommendation list includes at least one candidate accessory. In some embodiments, the at least one candidate accessory in the recommendation list is sorted in descending order of fitness with the target try-on part image, the first-ranked candidate accessory is determined as the target accessory, and the target accessory is superimposed and displayed on the body part in an AR form. In some embodiments, the recommendation list is obtained by analyzing, based on the AI algorithm, a reference standard corresponding to the target try-on part image. Different target try-on part images correspond to different reference standards. For example, when the target try-on part image is a hand image, a reference standard corresponding to the hand image includes but is not limited to at least one of a shape, a size, and a color of a hand. When the target try-on part image is a neck image, a reference standard corresponding to the neck image includes but is not limited to at least one of a color and smoothness of the neck.

In some embodiments, based on a selection operation on any candidate accessory in the recommendation list, the selected candidate accessory is superimposed and displayed on the body part in an AR form. In some embodiments, the user browses the recommendation list, and selects a candidate accessory in the recommendation list based on a preference of the user.

In some embodiments, the associated effect of the physical attribute corresponding to the target accessory on the body part is updated based on an interactive operation on the target accessory.

For example, the target accessory is moved on the body part based on a movement operation on the target accessory, and an associated effect of the physical attribute corresponding to the moved target accessory on the body part is displayed. For example, the target accessory is a ring, and a virtual product effect of the ring is worn on a middle finger by default. The user may move the ring from the middle finger to an index finger through a movement operation, to view a try-on effect of the virtual product effect of the ring worn on the index finger.

In some embodiments, based on a motion change of the body part, an associated effect following the motion change of the body part between the physical attribute corresponding to the target accessory and the body part is displayed. After the capture condition is satisfied, the current interface switches from the camera capture preview interface to the virtual trial interface, and the target accessory is automatically attached to the body part.

For example, the target accessory is a bracelet. After the capture condition is satisfied, the bracelet is automatically attached to a wrist location of the user. In some embodiments, a virtual product effect of the bracelet is moved with the wrist based on a movement operation of the wrist. The virtual product effect of the bracelet is rotated with the wrist based on a rotation operation of the wrist. The virtual product effect of the bracelet is shaken with the wrist based on a shaking operation of the wrist.

In some embodiments, a split-screen control is displayed. The split-screen control is configured for triggering the virtual trial interface to perform split-screen display. The virtual trial interface is an interface displaying the associated effect of the accessory decoration effect corresponding to the target accessory on the body part. The virtual trial interface and the short video playback interface are controlled to be displayed on a comparison interface in a split-screen form based on a trigger operation on the split-screen operation.

In some embodiments of the present disclosure, when the recommendation medium is the recommendation short video, the first accessory and the virtual interactive control are displayed on the short video playback interface, so that the user may trigger the virtual interactive control to enter the camera capture preview interface, and interact on the camera capture preview interface based on the prompt information. After the target try-on part image satisfies the capture condition, the associated effect of the physical attribute corresponding to the target accessory on the body part is displayed on the virtual trial interface. For example, AR interaction is performed based on the prompt information, the virtual product effect of the target accessory is previewed through AR, and the virtual product effect of the target accessory is superimposed and displayed on the body part in an AR form, ensuring fusion of the virtual product effect of the target accessory and a real scenario. A same product as the recommended product (the first accessory) or a product of a similar type is recommended to the user through the trigger operation on the virtual interactive control, implementing a personalized recommendation service. Such a recommendation manner not only improves recommendation accuracy, but also increases an interaction frequency between the user and the information feed advertisement, improving a click-through rate of the information feed advertisement.

In an application scenario, the recommendation-based interaction method may be applied to the field of furniture trials. In some embodiments, the target recommended product is a furniture product, the target object image is a target spatial location image, and the target part is a target spatial location. An example in which the recommendation medium is the recommendation short video is used for description.

Operation 1: Display a recommendation short video of first furniture and a virtual interactive control on a short video playback interface.

For example, a social interaction platform is installed and run on the terminal device. For example, an example in which a recommendation medium of the first furniture is the recommendation short video is used for description. The social interaction platform is designed with the short video playback interface. The short video playback interface includes social content that is published by at least one content publishing account and that is arranged by time. In some embodiments, the content publishing account is an advertisement account. The social content published by the content publishing account is advertisement content.

In some embodiments, the recommendation short video of the first furniture and the virtual interactive control are displayed on the short video playback interface. For example, the first furniture may be a television, a sofa, or a lamp.

Operation 2: Display a camera capture preview interface based on a trigger operation on the virtual interactive control.

In some embodiments, the trigger operation on the virtual interactive control includes a direct trigger operation and an indirect trigger operation. The indirect trigger operation on the virtual interactive control may be implemented by using a reaction component. In some embodiments, based on a positive reaction operation on the reaction component, it is determined that a condition of the indirect trigger operation on the virtual interactive control is satisfied.

In some embodiments, the camera capture preview interface is displayed based on the trigger operation on the virtual interactive control, the camera capture preview interface including prompt information configured for guiding capture of a target spatial location image. The target spatial location image is an image corresponding to a location related to an action location of the first furniture. The prompt information is instructive information or a visual auxiliary element presented to the user on the camera capture preview interface. The prompt information is configured for showing the user how to capture the target spatial location image on the camera capture preview interface based on the camera.

In some embodiments, the prompt information is a guidance mask. The guidance mask may be a layer of preset transparency that covers the camera capture preview interface. The guidance mask is configured for guiding the user to capture the target spatial location image. A shape of the guidance mask is related to a regional location at which the first furniture is placed.

For example, the first furniture is a television, the pre-captured target spatial location image is an image corresponding to a regional location at which the television is placed, and the guidance mask may be displayed as a layer in a shape of a television cabinet. For another example, the first furniture is a lamp, the pre-captured target spatial location image is an image corresponding to a regional location requiring lighting, and the guidance mask may be displayed as a desk-shaped layer.

In some embodiments, the camera capture preview interface includes a capture box, and the guidance mask is displayed in the capture box. The capture box is located in a target region on the camera capture preview interface. A display form of the capture box is a rectangular frame form, a circular frame form, or a frame form of another shape. The target region is a display region of the capture box. The target region may be a preset region or a dynamically changing region. In some embodiments, a display size of the capture box changes with a distance between the target spatial location and the camera.

In some embodiments, the camera capture preview interface further includes capture prompt information. The capture prompt information is prompt information configured for guiding the target spatial location image to a location of the guidance mask. In some embodiments, a type of the capture prompt information includes but is not limited to at least one of text prompt information, arrow prompt information, and voice prompt information.

Operation 3: Display, based on the target spatial location image satisfying a capture condition, an associated effect of a physical attribute corresponding to target furniture on the target spatial location.

The capture condition is a standard condition that needs to be satisfied by the camera of the terminal device when capturing the target spatial location image. The target furniture is the first furniture or second furniture belonging to a same type as the first furniture. The associated effect is a visual effect or an application effect generated when the physical attribute of the target furniture is combined with the target spatial location. The physical attribute is an actual physical feature such as a size and a material of the target furniture. In some embodiments, the associated effect acting on the target spatial location is a virtual product effect.

The associated effect of the physical attribute corresponding to the target furniture on the target spatial location is displayed based on the target spatial location image satisfying the capture condition or based on an overlap degree between the target spatial location image and the guidance mask satisfying a first threshold. The associated effect is the virtual product effect of the target furniture. For example, the target furniture is placed and displayed at the target spatial location in an AR form on a virtual trial interface.

The overlap degree is an overlapping degree between the target spatial location image and the guidance mask. The overlap degree is configured for measuring consistency between the target spatial location and the guidance mask. If the overlap degree reaches or exceeds the preset first threshold, an effect of the target furniture being placed and displayed at the target spatial location in an AR form is displayed.

In some embodiments, the target spatial location image is analyzed based on an AI algorithm based on the overlap degree between the target spatial location image and the guidance mask satisfying the first threshold, to obtain a recommendation list. The recommendation list includes at least one piece of candidate furniture. In some embodiments, the at least one piece of candidate furniture in the recommendation list is sorted in descending order of fitness with the target spatial location image, first-ranked candidate furniture is determined as the target furniture, and the target furniture is placed and displayed at the target spatial location in an AR form.

In some embodiments, based on a selection operation on any piece of candidate furniture in the recommendation list, the selected candidate furniture is placed and displayed at the target spatial location in an AR form. In some embodiments, the user browses the recommendation list, and selects candidate furniture in the recommendation list based on a preference of the user.

In some embodiments, the associated effect of the physical attribute corresponding to the target furniture on the target spatial location is updated based on an interactive operation on the target furniture.

For example, the target furniture is moved based on a movement operation on the target furniture, and an associated effect of the physical attribute corresponding to the moved target furniture on the target spatial location is displayed. For example, the target furniture is a sofa. The sofa is displayed at a central regional location on the ground of a living room by default. In some embodiments, a virtual product effect of the sofa after the sofa is moved from a central regional location A to another regional location B is displayed based on a movement operation on the sofa.

For example, the target furniture is zoomed in, based on a zoom-in operation on the target furniture, and an associated effect of the physical attribute corresponding to the zoomed-in target furniture on the target spatial location is displayed at the target spatial location. For example, the target furniture is a sofa, and a preset size of the sofa is displayed. In some embodiments, a virtual product effect after the sofa is zoomed in from the preset size to a changed size is displayed based on a zoom-in operation on the sofa.

In some embodiments, a split-screen control is displayed. The split-screen control is configured for triggering the virtual trial interface to perform split-screen display. The virtual trial interface is an interface displaying the associated effect of the physical attribute corresponding to the target furniture on the target spatial location. The virtual trial interface and the short video playback interface are controlled to be displayed on a comparison interface in a split-screen form based on a trigger operation on the split-screen operation.

In some embodiments of the present disclosure, when the recommendation medium is the recommendation short video, the first furniture and the virtual interactive control are displayed on the short video playback interface, so that the user may trigger the virtual interactive control to enter the camera capture preview interface, and interact on the camera capture preview interface based on the prompt information. After the target spatial location image satisfies the capture condition, the associated effect of the physical attribute corresponding to the target furniture on the target spatial location is displayed on the virtual trial interface. For example, AR interaction is performed based on the prompt information, the virtual product effect of the target furniture is previewed through AR, and the virtual product effect of the target furniture is placed and displayed at the target spatial location in an AR form, ensuring fusion of the virtual product effect of the target furniture and a real scenario. A same product as the recommended product (the first furniture) or a product of a similar type is recommended to the user through the trigger operation on the virtual interactive control, implementing a personalized recommendation service. Such a recommendation manner not only improves recommendation accuracy, but also increases an interaction frequency between the user and the information feed advertisement, improving a click-through rate of the information feed advertisement.

Beneficial effects of this solution
(1) Through AR virtual try-on or AR virtual trial, the user can intuitively feel the try-on effect or the trial effect of the recommended product, enhancing decision-making confidence.
(2) The target object image of the user is analyzed by using the AI algorithm, to obtain the at least one candidate recommended product, and personalized product recommendation is provided, improving user satisfaction.
(3) Interactive advertisement experience is provided by combining AR and AI technologies, and user engagement and an advertisement effect are improved.

FIG. 13 is a block diagram of a structure of a recommendation-based interaction apparatus according to some embodiments of the present disclosure. The apparatus has a function of implementing the examples of the recommendation-based interaction method. The function may be implemented by hardware, or may be implemented by hardware executing corresponding software. The apparatus may be the server described above, or may be disposed in the server. As shown in FIG. 13, the apparatus 1300 may include a display module 1310.

The display module 1310 is configured to display a recommendation medium of a first recommended product and a virtual interactive control.

The display module 1310 is configured to display a camera capture preview interface based on a trigger operation on the virtual interactive control, the camera capture preview interface including prompt information configured for guiding capture of a target object image.

The display module 1310 is configured to display, on a virtual trial interface based on the target object image satisfying a capture condition, an associated effect of a physical attribute corresponding to a target recommended product on a target part, the target part being a location in the target object image that is related to an action location of the first recommended product.

The target recommended product is the first recommended product or a second recommended product belonging to a same type as the first recommended product.

In some embodiments, the display module 1310 further includes a display submodule.

In an example, the prompt information is a guidance mask, and the guidance mask is configured to guiding capture of the target object image. The display submodule is configured to display, on the virtual trial interface based on an overlap degree between the target object image and the guidance mask satisfying a first threshold, the associated effect of the physical attribute corresponding to the target recommended product on the target part.

In some embodiments, the display submodule further includes an analysis unit and a display unit.

In an example, the analysis unit is configured to analyze the target object image based on an artificial intelligence (AI) algorithm based on the overlap degree between the target object image and the guidance mask satisfying the first threshold, to obtain a recommendation list, the recommendation list including at least one candidate recommended product.

The display unit is configured to determine the target recommended product based on the recommendation list, and display, on the virtual trial interface, the associated effect of the physical attribute corresponding to the target recommended product on the target part.

In an example, the display unit is configured to display the at least one candidate recommended product in descending order of fitness with the target object image.

The display unit is configured to determine an n^{th} candidate recommended product in the descending order as the target recommended product, and display, on the virtual trial interface, the associated effect of the physical attribute corresponding to the target recommended product on the target part, n being a positive integer.

In an example, the display unit is configured to determine, from the recommendation list based on fitness between the at least one candidate recommended product and the target object image, a candidate recommended product whose fitness with the target object image reaches a second threshold as the target recommended product, and display, on the virtual trial interface, the associated effect of the physical attribute corresponding to the target recommended product on the target part.

In an example, the display unit is configured to determine, based on a selection operation on a candidate recommended product in the recommendation list, the candidate recommended product selected through the selection operation as the target recommended product, and display, on the virtual trial interface, the associated effect of the physical attribute corresponding to the selected target recommended product on the target part.

In an example, the display submodule is configured to update the associated effect of the physical attribute corresponding to the target recommended product on the target part based on an interactive operation on the target recommended product.

In an example, the display unit is configured to rotate an angle of the target recommended product based on a first interactive operation on the target recommended product, and display, on the target part, an associated effect of the physical attribute corresponding to the rotated target recommended product on the target part.

Alternatively, the display unit is configured to zoom in the target recommended product based on a second interactive operation on the target recommended product, and display, on the target part, an associated effect of the physical attribute corresponding to the zoomed-in target recommended product on the target part.

Alternatively, the display unit is configured to zoom out the target recommended product based on a third interactive operation on the target recommended product, and display, on the target part, an associated effect of the physical attribute corresponding to the zoomed-out target recommended product on the target part.

Alternatively, the display unit is configured to move the target recommended product based on a fourth interactive operation on the target recommended product, and display, on the target part, an associated effect of the physical attribute corresponding to the moved target recommended product on the target part.

In an example, the display submodule is configured to display, based on a motion change of the target part, an associated effect following the motion change of the target part between the physical attribute corresponding to the target recommended product and the target part.

In an example, the display submodule is configured to display, in a switched virtual background based on a switching operation on a virtual background of the virtual trial interface, the associated effect of the physical attribute corresponding to the target recommended product on the target part, different virtual backgrounds being configured for simulating different real life scenarios.

In an example, the target recommended product is a recommended product of a first brand. The display submodule is configured to display a recommended product of a second brand in a preset region on the virtual trial interface.

The display submodule is configured to navigate to a details interface of the recommended product of the second brand based on a selection operation on the recommended product of the second brand.

In an example, the display submodule is configured to display a split-screen control, the split-screen control being configured for triggering split-screen display of the virtual trial interface.

The display submodule is configured to control, based on a trigger operation on the split-screen control, the virtual trial interface and a presentation interface to be displayed in a split-screen form, the presentation interface being an interface configured for presenting the first recommended product.

In an example, the display submodule is configured to display a share control, the share control being configured for triggering a first account to share the virtual trial interface with a second account.

The display submodule is configured to display an interaction frame of the first account and the second account on the virtual trial interface based on a joining operation of the second account.

In an example, the recommendation medium is a recommendation short video, and the recommendation short video includes content of a trial of the first recommended product by a model figure. The display submodule is configured to display, in the recommendation short video based on a first switching operation on a color of the first recommended product, content of a virtual product effect of the first recommended product after color switching acting on the model figure, and display promotion content corresponding to the first recommended product after color switching.

In an example, the display submodule is configured to display, in the recommendation short video based on a second switching operation on a model of the first recommended product, content of a product effect of the first recommended product after model switching acting on the model figure, and display promotion content corresponding to the first recommended product after model switching.

In some embodiments, the apparatus 1300 further includes an execution module.

In an example, the execution module is configured to perform conversion processing based on the virtual try-on interface, the conversion processing including at least one of navigating to a purchase interface of the target recommended product, navigating to an introduction interface of the target recommended product, and navigating to an interactive interface of the target recommended product.

In an example, a conversion entry is displayed around the target recommended product. The display submodule is configured to display, based on a trigger operation on the conversion entry, a recommendation landing page corresponding to the target recommended product, the recommendation landing page displaying detailed content related to the target recommended product.

For specific limitations in the foregoing one or more embodiments of the recommendation-based interaction apparatus, refer to the foregoing limitations on the recommendation-based interaction method. Details are not described herein again. The modules of the foregoing apparatus may be all or partially implemented by software, hardware, and a combination thereof. Each module may be embedded in or independent of a processor of a computer device in a form of hardware, or may be stored in a memory of a computer device in a form of software, for a processor to invoke to perform an operation corresponding to the module.

The sequence numbers of some embodiments of the present disclosure are merely for description and do not represent superiority-inferiority of the embodiments.

Some embodiments of the present disclosure further provides a computer device. The computer device includes a processor and a memory. The memory has at least one computer program stored therein. The at least one computer program is loaded and executed by the processor to implement the recommendation-based interaction method provided in the foregoing method embodiments.

One or more components of FIG. 13 may be integrated into a single component, or conversely, a single component may be implemented as multiple discrete elements. Additionally or alternatively, different subsets of the illustrated components may be combined in various configurations.

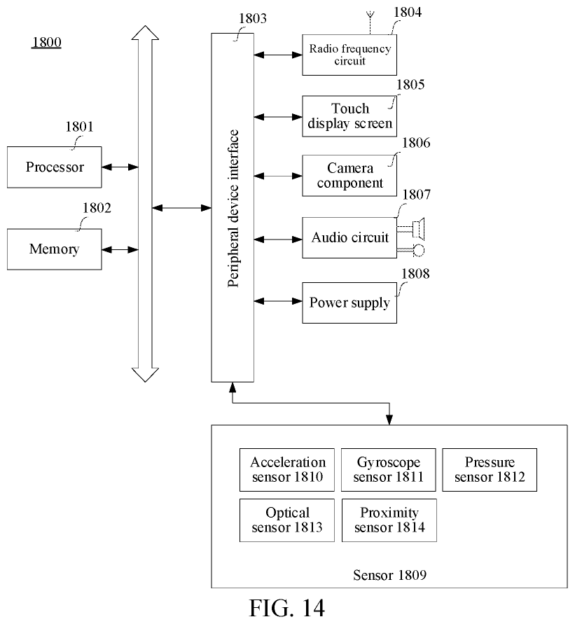

FIG. 14 is a block diagram of a structure of a computer device 1800 according to some embodiments of the present disclosure. The computer device 1800 may be a portable mobile terminal, for example, a smartphone, a tablet computer, a moving picture experts group audio layer III (MP3) player, or a moving picture experts group audio layer IV (MP4) player. The computer device 1800 may also be referred to as user equipment, a portable terminal, or another name. For example, the computer device 1800 includes a processor 1801 and a memory 1802.

The processor 1801 may include one or more processing cores, for example, a four-core processor or an eight-core processor. The processor 1801 may be implemented in at least one hardware form of a digital signal processor (DSP), a field programmable gate array (FPGA), and a programmable logic array (PLA). The processor 1801 may alternatively include a main processor and a coprocessor. The main processor is a processor configured to process data in an awake state, and is also referred to as a central processing unit (CPU). The coprocessor is a low power consumption processor configured to process data in a standby state. In some embodiments, the processor 1801 may be integrated with a graphics processing unit (GPU), and the GPU is configured to render and draw content that needs to be displayed on a display screen. In some embodiments, the processor 1801 may alternatively include an artificial intelligence (AI) processor. The AI processor is configured to process computing operations related to machine learning.

The memory 1802 may include one or more computer-readable storage media. The computer-readable storage medium may be tangible and non-transitory. The memory 1802 may further include a high-speed random access memory and a non-volatile memory, for example, one or more disk storage devices and flash storage devices. In some embodiments, the non-transitory computer-readable storage medium in the memory 1802 is configured to store at least one instruction, and the at least one instruction is configured for being executed by the processor 1801 to implement the recommendation-based interaction method provided in some embodiments of the present disclosure.

In some embodiments, the computer device 1800 may further include a peripheral device interface 1803 and at least one peripheral device. The processor 1801, the memory 1802, and the peripheral device interface 1803 may be connected to each other through a bus or a signal cable. Each peripheral device may be connected to the peripheral device interface 1803 through a bus, a signal cable, or a circuit board. For example, the peripheral device includes at least one of a radio frequency circuit 1804, a touch display screen 1805, a camera component 1806, an audio circuit 1807, and a power supply 1808.

The peripheral device interface 1803 may be configured to connect at least one peripheral device related to input/output (I/O) to the processor 1801 and the memory 1802. In some embodiments, the processor 1801, the memory 1802, and the peripheral device interface 1803 are integrated on a same chip or circuit board. In some other embodiments, any one or two of the processor 1801, the memory 1802, and the peripheral device interface 1803 may be implemented on a single chip or circuit board. This is not limited in this embodiment.

The radio frequency circuit 1804 is configured to receive and transmit a radio frequency (RF) signal, which is also referred to as an electromagnetic signal. The radio frequency circuit 1804 communicates with a communication network and another communication device by using the electromagnetic signal. The radio frequency circuit 1804 converts an electric signal into an electromagnetic signal for transmission, or converts a received electromagnetic signal into an electric signal. In some embodiments, the radio frequency circuit 1804 includes an antenna system, an RF transceiver, one or more amplifiers, a tuner, an oscillator, a digital signal processor, a codec chipset, a subscriber identity module card, and the like. The radio frequency circuit 1804 may communicate with another terminal by using at least one wireless communication protocol. The wireless communication protocol includes but is not limited to a world wide web, a metropolitan area network, an intranet, generations of mobile communication networks (2^{nd} generation (2G), 3^{rd} generation (3G), 4^{th} generation (4G), and 5^{th} generation (5G)), a wireless local area network, and/or a wireless fidelity (Wi-Fi) network. In some embodiments, the radio frequency circuit 1804 may further include a circuit related to near field communication (NFC). This is not limited in the present disclosure.

The touch display screen 1805 is configured to display a user interface (UI). The UI may include a graph, a text, an icon, a video, and any combination thereof. The touch display screen 1805 also has a capability of acquiring a touch signal on or above a surface of the touch display screen 1805. The touch signal may be inputted to the processor 1801 as a control signal for processing. The touch display screen 1805 is configured to provide a virtual button and/or a virtual keyboard, which is also referred to as a soft button and/or a soft keyboard. In some embodiments, there may be one touch display screen 1805 disposed on a front panel of the computer device 1800. In some other embodiments, there may be at least two touch display screens 1805 disposed on different surfaces of the computer device 1800 or in a folded design. In some embodiments, the touch display screen 1805 may be a flexible display screen, and is disposed on a curved surface or a folded surface of the computer device 1800. Even, the touch display screen 1805 may be further configured in a non-rectangular irregular pattern, e.g., is a special-shaped screen. The display screen 1805 may be manufactured by using a liquid crystal display (LCD), an organic light-emitting diode (OLED), or the like.

The camera component 1806 is configured to acquire images or videos. In some embodiments, the camera component 1806 includes a front camera and a rear camera. For example, the front camera is configured to implement a video call or self-portrait, and the rear camera is configured to shoot a picture or a video. In some embodiments, there are at least two rear cameras, each of which is any one of a main camera, a depth of field camera, and a wide-angle camera, to implement a background blurring function by fusing the main camera and the depth of field camera, and panoramic shooting and virtual reality (VR) shooting functions by fusing the main camera and the wide-angle camera. In some embodiments, the camera component 1806 may further include a flash. The flash may be a mono color temperature flash or a double color temperature flash. The double color temperature flash is a combination of a warm light flash and a cold light flash, and may be configured for light compensation under different color temperatures.

The audio circuit 1807 is configured to provide an audio interface between a user and the computer device 1800. The audio circuit 1807 may include a microphone and a speaker. The microphone is configured to acquire sound waves of the user and an environment, convert the sound waves into an electrical signal, and input the electrical signal into the processor 1801 for processing, or input the electrical signal into the radio frequency circuit 1804 for implementing voice communication. For the purpose of stereo sound acquisition or noise reduction, there may be a plurality of microphones, respectively arranged at different parts of the computer device 1800. The microphone may alternatively be an array microphone or an omni-directional capture microphone. The speaker is configured to convert electrical signals from the processor 1801 or the radio frequency circuit 1804 into sound waves. The speaker may be a film speaker or a piezoelectric ceramic speaker. When the speaker is the piezoelectric ceramic speaker, the speaker not only can convert an electrical signal into acoustic waves audible to a human being, but also can convert an electrical signal into acoustic waves inaudible to a human being, for ranging and other purposes. In some embodiments, the audio circuit 1807 may further include a headset jack.

The power supply 1808 is configured to supply power to each component of the computer device 1800. The power supply 1808 may be an alternating current, a direct current, a primary battery, or a rechargeable battery. When the power supply 1808 includes a rechargeable battery, the rechargeable battery may be a wired rechargeable battery or a wireless rechargeable battery. The wired rechargeable battery is a battery charged through a wired cable. The wireless rechargeable battery is a battery charged through a wireless coil. The rechargeable battery may be further configured to support a fast charge technology.

In some embodiments, the computer device 1800 further includes one or more sensors 1809. The one or more sensors 1809 include but are not limited to an acceleration sensor 1810, a gyroscope sensor 1811, a pressure sensor 1812, an optical sensor 1813, and a proximity sensor 1814.

The acceleration sensor 1810 may detect a magnitude of acceleration on three coordinate axes of a coordinate system established by the computer device 1800. For example, the acceleration sensor 1810 may be configured to detect components of gravity acceleration on the three coordinate axes. The processor 1801 may control, based on a gravity acceleration signal acquired by the acceleration sensor 1810, the touch display screen 1805 to display the user interface in a landscape view or a portrait view. The acceleration sensor 1810 may be further configured to collect motion data of a game or the user. The gyroscope sensor 1811 may detect a body direction and a rotation angle of the computer device 1800. The gyroscope sensor 1811 may cooperate with the acceleration sensor 1810 to acquire a 3D action performed by the user on the computer device 1800. The processor 1801 may implement the following functions based on the data acquired by the gyroscope sensor 1811: motion sensing (such as changing the UI based on a tilt operation of the user), image stabilization at shooting, game control, and inertial navigation.

The pressure sensor 1812 may be disposed at a side frame of the computer device 1800 and/or a lower layer of the touch display screen 1805. When the pressure sensor 1812 is disposed at the side frame of the computer device 1800, a holding signal of the user on the computer device 1800 may be detected, and left and right hand identification or a quick operation may be performed based on the holding signal. When the pressure sensor 1812 is disposed at the low layer of the touch display screen 1805, an operable control on the UI may be controlled based on a pressure operation of the user on the touch display screen 1805. The operable control includes at least one of a button control, a scroll bar control, an icon control, and a menu control.

The optical sensor 1813 is configured to acquire an ambient light intensity. In some embodiments, the processor 1801 may control display brightness of the touch display screen 1805 based on the ambient light intensity acquired by the optical sensor 1813. For example, when the ambient light intensity is high, the display brightness of the touch display screen 1805 is increased; or when the ambient light intensity is low, the display brightness of the display screen 1805 is decreased. In some embodiments, the processor 1801 may further dynamically adjust a camera parameter of the camera component 1806 based on the ambient light intensity acquired by the optical sensor 1813.

The proximity sensor 1814, also referred to as a distance sensor, is disposed on a front surface of the computer device 1800. The proximity sensor 1814 is configured to acquire a distance between the user and the front surface of the computer device 1800. In some embodiments, when the proximity sensor 1814 detects that the distance between the user and the front surface of the computer device 1800 gradually decreases, the processor 1801 controls the touch display screen 1805 to switch from a screen-on state to a screen-off state; or when the proximity sensor 1814 detects that the distance between the user and the front surface of the computer device 1800 gradually increases, the processor 1801 controls the touch display screen 1805 to switch from a screen-off state to a screen-on state.

A person skilled in the art may understand that the foregoing structure does not constitute any limitation on the computer device 1800, and the computer device 1800 may include more components or fewer components than those shown in the figure, or some components may be combined, or a different component deployment may be used.

One or more components of FIG. 14 may be integrated into a single component, or conversely, a single component may be implemented as multiple discrete elements. Additionally or alternatively, different subsets of the illustrated components may be combined in various configurations.

Some embodiments of the present disclosure further provides a computer-readable storage medium. The computer-readable storage medium has at least one computer program stored therein. The at least one computer program is loaded and executed by a processor to implement the recommendation-based interaction method provided in the foregoing method embodiments.

Some embodiments of the present disclosure further provides a computer program product. The computer program product includes at least one computer program. The at least one computer program is stored in a computer-readable storage medium. The at least one computer program is read from the computer-readable storage medium and executed by a processor of a computer device, to enable the computer device to perform the recommendation-based interaction method provided in the foregoing method embodiments.

“A plurality of” mentioned in this the present disclosure means two or more. The term “and/or” describes an association relationship between associated objects and represents that three relationships may exist. For example, A and/or B may represent the following three cases: Only A exists, both A and B exist, and only B exists. The character “/” indicates an “or” relationship between the associated objects. In addition, the operation numbers described in the present disclosure merely show a possible execution sequence of the operations as an example. In some other embodiments, the foregoing operations may not be performed based on the number sequence. For example, two operations with different numbers may be performed simultaneously, or two operations with different numbers may be performed based on a sequence contrary to the sequence shown in the figure. This is not limited in some embodiments of the present disclosure.

A person of ordinary skill in the art may understand that all or a part of the operations in the foregoing embodiments may be completed by hardware or by a program instructing related hardware. The program may be stored in a computer-readable storage medium. The storage medium may be a read-only memory, a magnetic disk, an optical disk, or the like.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A method for recommendation-based interaction, the method comprising:
displaying a recommendation medium of a first recommended product and a virtual interactive control;
displaying a camera capture preview interface based on a trigger operation on the virtual interactive control, the camera capture preview interface comprising prompt information configured to guide capture of a target object image; and
displaying, on a virtual trial interface based on the target object image satisfying a capture condition, an associated effect of a physical attribute corresponding to a target recommended product on a target part, the target part comprising a location in the target object image that is related to an action location of the first recommended product,
wherein the target recommended product comprises the first recommended product or a second recommended product belonging to a same type as the first recommended product.

2. The method according to claim 1, wherein the prompt information comprises a guidance mask configured to guide capture of the target object image, and
wherein the displaying, on the virtual trial interface based on the target object image satisfying a capture condition, the associated effect of the physical attribute corresponding to the target recommended product on the target part comprises:
displaying, on the virtual trial interface based on an overlap degree between the target object image and the guidance mask satisfying a first threshold, the associated effect of the physical attribute corresponding to the target recommended product on the target part.

3. The method according to claim 2, wherein the displaying, on the virtual trial interface based on the overlap degree between the target object image and the guidance mask satisfying the first threshold, of the associated effect of the physical attribute corresponding to the target recommended product on the target part comprises:
analyzing the target object image based on an artificial intelligence (AI) algorithm when the overlap degree between the target object image and the guidance mask satisfies the first threshold, to obtain a recommendation list comprising at least one candidate recommended product;
determining the target recommended product based on the recommendation list; and
displaying, on the virtual trial interface, the associated effect of the physical attribute corresponding to the target recommended product on the target part.

4. The method according to claim 3, wherein the determining of the target recommended product based on the recommendation list comprises:
displaying the at least one candidate recommended product in descending order based on fitness with the target object image;
determining an n^{th} candidate recommended product in the descending order as the target recommended product; and
displaying, on the virtual trial interface, the associated effect of the physical attribute corresponding to the target recommended product on the target part, n being a positive integer.

5. The method according to claim 3, wherein the determining of the target recommended product based on the recommendation list comprises:
determining, from the recommendation list based on fitness between the at least one candidate recommended product and the target object image, a candidate recommended product whose fitness with the target object image reaches a second threshold as the target recommended product; and
displaying, on the virtual trial interface, the associated effect of the physical attribute corresponding to the target recommended product on the target part.

6. The method according to claim 3, wherein the determining of the target recommended product based on the recommendation list comprises:
determining, based on a selection operation on a candidate recommended product in the recommendation list, the candidate recommended product selected through the selection operation as the target recommended product; and
displaying, on the virtual trial interface, the associated effect of the physical attribute corresponding to the target recommended product on the target part.

7. The method according to claim 1, wherein the method further comprises:
updating the associated effect of the physical attribute corresponding to the target recommended product on the target part based on an interactive operation on the target recommended product.

8. The method according to claim 7, wherein the updating of the associated effect of the physical attribute corresponding to the target recommended product on the target part based on an interactive operation on the target recommended product comprises:
rotating an angle of the target recommended product based on a first interactive operation on the target recommended product;
displaying, on the target part, an associated effect of the physical attribute corresponding to the rotated target recommended product on the target part;
zooming in the target recommended product based on a second interactive operation on the target recommended product;
displaying, on the target part, an associated effect of the physical attribute corresponding to the zoomed-in target recommended product on the target part;
zooming out the target recommended product based on a third interactive operation on the target recommended product;
displaying, on the target part, an associated effect of the physical attribute corresponding to the zoomed-out target recommended product on the target part;
moving the target recommended product based on a fourth interactive operation on the target recommended product; and
displaying, on the target part, an associated effect of the physical attribute corresponding to the moved target recommended product on the target part.

9. The method according to claim 1, wherein the method further comprises:
displaying, based on a motion change of the target part, an associated effect of the physical attribute corresponding to the target recommended product on the target part.

10. The method according to claim 1, wherein the method further comprises:
displaying, in a switched virtual background based on to a switching operation on a virtual background of the virtual trial interface, the associated effect of the physical attribute corresponding to the target recommended product on the target part, and
wherein different virtual backgrounds are configured to simulate different real life scenarios.

11. The method according to claim 1, wherein the target recommended product comprises a recommended product of a first brand, and
wherein the method further comprises:
displaying a recommended product of a second brand in a preset region on the virtual trial interface; and
navigating to a details interface of the recommended product of the second brand based on a selection operation on the recommended product of the second brand.

12. The method according to claim 11, wherein the method further comprises:
displaying a split-screen control configured to trigger split-screen display of the virtual trial interface; and
controlling, based on a trigger operation on the split-screen control, the virtual trial interface and a presentation interface to be displayed in a split-screen form, the presentation interface being an interface configured to present the first recommended product.

13. The method according to claim 1, wherein the method further comprises:
displaying a share control configured to trigger a first account to share the virtual trial interface with a second account; and
displaying an interaction frame of the first account and the second account on the virtual trial interface based on a joining operation of the second account.

14. The method according to claim 1, wherein the recommendation medium comprises a recommendation short video that comprises content of trial of the first recommended product by a model figure, and
wherein the method further comprises displaying, in the recommendation short video based on a first switching operation on a color of the first recommended product, content of a virtual product effect of the first recommended product based on:
performing color switching on the model figure; and
displaying promotion content corresponding to the first recommended product based on performing of the color switching.

15. The method according to claim 14, wherein the method further comprises:
displaying, in the recommendation short video based on a second switching operation on a model of the first recommended product, content of a product effect of the first recommended product when model switching is performed on the model figure; and
displaying promotion content corresponding to the first recommended product when the model switching is performed.

16. The method according to claim 1, wherein the method further comprises:
performing conversion processing based on the virtual trial interface, the conversion processing comprising at least one of:
navigating to a purchase interface of the target recommended product;
navigating to an introduction interface of the target recommended product; or
navigating to an interactive interface of the target recommended product.

17. The method according to claim 1, wherein a conversion entry is displayed around the target recommended product, and
wherein the method further comprises displaying, based on a trigger operation on the conversion entry, a recommendation landing page corresponding to the target recommended product, the recommendation landing page displaying detailed content related to the target recommended product.

18. An apparatus for recommendation based interaction, the apparatus comprising:
at least one memory configured to store computer program code; and at least one processor configured to read the program code and operate as instructed by the program code, the program code comprising:
display code configured to cause the at least one processor to:
display a recommendation medium of a first recommended product and a virtual interactive control;
display a camera capture preview interface based on a trigger operation on the virtual interactive control, the camera capture preview interface comprising prompt information configured to guide capture of a target object image; and
display, on a virtual trial interface based on the target object image satisfying a capture condition, an associated effect of a physical attribute corresponding to a target recommended product on a target part, the target part being a location in the target object image that is related to an action location of the first recommended product,
wherein the target recommended product comprises the first recommended product or a second recommended product belonging to a same type as the first recommended product.

19. The apparatus of according to claim 18, wherein the prompt information comprises a guidance mask being configured to guide capture of the target object image, and
wherein the display code is further configured to cause the at least one processor to:
display, on the virtual trial interface based on an overlap degree between the target object image and the guidance mask satisfying a first threshold, the associated effect of the physical attribute corresponding to the target recommended product on the target part.

20. A non-transitory computer-readable storage medium, storing computer program code, when executed by at least one processor, causes the at least one processor to at least:
display a recommendation medium of a first recommended product and a virtual interactive control;
display a camera capture preview interface based on a trigger operation on the virtual interactive control, the camera capture preview interface comprising prompt information configured to guide capture of a target object image; and
display, on a virtual trial interface based on the target object image satisfying a capture condition, an associated effect of a physical attribute corresponding to a target recommended product on a target part, the target part being a location in the target object image that is related to an action location of the first recommended product,
wherein the target recommended product comprises the first recommended product or a second recommended product belonging to a same type as the first recommended product.
